(19) United States
(12) Patent Application Publication
(10) Pub. No.: US 2013/0120239 A1
(43) Pub. Date: May 16, 2013

(54) INFORMATION PROCESSING DEVICE, CONTROL METHOD, AND PROGRAM

(71) Applicant: Sony Corporation, Tokyo (JP)

(72) Inventors: Seiji SUZUKI, Kanagawa (JP); Shunichi KASAHARA, Kanagawa (JP); Yasuyuki KOGA, Kanagawa (JP); Osamu SHIGETA, Tokyo (JP); Kazuyuki YAMAMOTO, Kanagawa (JP)

(73) Assignee: SONY CORPORATION, Tokyo (JP)

(21) Appl. No.: 13/666,361

(22) Filed: Nov. 1, 2012

(30) Foreign Application Priority Data
Nov. 14, 2011 (JP) 2011248605

(51) Int. Cl. G06F 3/01

(52) U.S. Cl. 345/156

(57) ABSTRACT

There is provided an information processing device including a display screen having flexibility; a deflection detection unit configured to detect deflection of the display screen; and a control unit configured to recognize a change in the deflection detected by the deflection detection unit as an on operation input and output a corresponding process command.

### BACKGROUND

The present disclosure relates to an information processing device, a control method, and a program.

As a method of inputting a user operation, there are known a method that uses an input device such as a keyboard or a mouse, and a method that uses a pen, a touch screen, a button, or a jog-dial controller. However, as an input device such as a keyboard or a mouse has bad portability, it is not suitable for mobile devices. Meanwhile, when a method that uses a touch screen or the like is used, the shape of the device does not change even when the touch screen is touched strongly. Thus, it 115 is impossible for a user to intuitively sense to what degree the strength of the touch is reflected by the input operation.

In contrast, in recent years, a thin, lightweight electronic display having flexibility (a flexible display) and a flexible touch panel have been proposed.

For example, JP 2007-52129A describes an invention related to a flexible display. In addition, JP 2010-157060A proposes an interface that can input a user operation by physically curving or distorting the main body of the device.

### SUMMARY

However, although JP 2010-157060A describes switching the displayed content according to the position of curve of the main body of the display device and the pressure applied thereto, no mention is made of an operation that is input according to a temporal change in the state of curve (deflection).

Thus, the present disclosure proposes an information processing device, a control method, and a program that are novel and improved and can further improve the convenience of inputting a curving operation by recognizing a change in deflection as an operation input.

According to an embodiment of the present disclosure, there is provided an information processing device including a display screen having flexibility; a deflection detection unit configured to detect deflection of the display screen; and a control unit configured to recognize a change in the deflection detected by the deflection detection unit as an on operation input and output a corresponding process command.

According to another embodiment of the present disclosure, there is provided a control method including detecting deflection of a display screen having flexibility; and recognizing a change in the deflection detected in the deflection detection step as an on operation input and outputting a corresponding process command.

According to still another embodiment of the present disclosure, there is provided a program for causing a computer to execute the processes of detecting deflection of a display screen having flexibility; and performing control of recognizing a change in the deflection detected in the deflection detection process as an on operation input and outputting a corresponding process command.

As described above, according to the embodiments of the present disclosure, it is possible to further improve the convenience of inputting a curving operation.

### BRIEF DESCRIPTION OF THE DRAWINGS

FIG. 1 is an external view of an information processing device according to an embodiment of the present disclosure;

FIG. 2 is a diagram showing an exemplary hardware configuration of an information processing device according to an embodiment of the present disclosure;

FIG. 3 is a diagram illustrating an exemplary arrangement of curvature sensors according to an embodiment of the present disclosure;

FIG. 4 is a functional block diagram illustrating the functional configuration of an information processing device according to an embodiment of the present disclosure;

FIG. 5 is a diagram illustrating a basic operation of Operation Example 1 according to a first embodiment;

FIG. 6 is a flowchart showing an operation process of Operation Example 1 according to the first embodiment;

FIG. 7 is a diagram illustrating an automatic alignment command in Operation Example 1 according to the first embodiment;

FIG. 8 is a diagram illustrating an automatic alignment command according to a pulled direction in Operation Example 1 according to the first embodiment;

FIG. 9 is a diagram illustrating a basic operation of Operation Example 2 according to the first embodiment;

FIG. 10 is a flowchart showing an operation process of Operation Example according to the first embodiment;

FIG. 11 is a diagram illustrating a noise removing command in Operation Example 2 according to the first embodiment;

FIG. 12 is a diagram illustrating a text summarizing command according to a flick operation in Operation Example 2 according to the first embodiment;

FIG. 13 is a diagram illustrating a data transfer command in Operation Example 2 according to the first embodiment;

FIG. 14 is a diagram illustrating a data transfer command in a variation according to the first embodiment;

FIG. 15 is a diagram showing, in an information processing device according to a second embodiment, a signal sequence including the amount of curve, detected from curvature sensors provided on the top side and curvature sensors provided on the bottom side, respectively, of a flexible display.

FIG. 16 is a diagram illustrating recognition of a center lire of curve according to the second embodiment;

FIG. 17 is a diagram illustrating display control of enlarging a list item according to a center line of curve in Display Control Example 1 according to the second embodiment;

FIG. 18 is a diagram illustrating discarding an input of a curving operation according to the angle of a center line of curve in Display Control Example 1 according to the second embodiment;

FIG. 19 is a diagram illustrating display control of enlarging text according to a center line of curve in Display Control Example 1 according to the second embodiment;

FIG. 20 is a diagram illustrating dynamic enlarging display control performed according to a change in a center line of curve in Display Control Example 1 according to the second embodiment;

FIG. 21 is a diagram illustrating control of aligning icons according to center line of curve in Display Control Example 2 according to the second embodiment;

FIG. 22 is a diagram illustrating bookmark display control in Display Control Example 3 according to the second embodiment;

FIG. 23 is a diagram illustrating page flipping display control in Display Control Example 3 according to the second embodiment;

FIG. 24 is a diagram illustrating display control according to a held state in Display Control Example 4 according to the second embodiment;

FIG. 25 is a diagram illustrating display inversion control in Display Control Example 5 according to the second embodiment;

FIG. 26 is a diagram illustrating a rolled-up state according to a third embodiment;

FIG. 27 is a diagram illustrating the amount of curve detected from each curvature sensor an information processing device according to the third embodiment;

FIG. 28 is a diagram illustrating dispersion of the amount of curve detected from each curvature sensor in the information processing device according to the third embodiment;

FIG. 29 is a flowchart showing an example of an operation process according to the third embodiment;

FIG. 30 is a diagram illustrating a function executed by a control unit 115 according to the third embodiment in response to an input of a roll-up operation;

FIG. 31 is a diagram illustrating that the control unit 115 according to the third embodiment turns off a touch operation detection function according to a roiled-up state;

FIG. 32 is a diagram illustrating another example of display control according to an embodiment of the present disclosure; and

FIG. 33 is a diagram illustrating another example of display control according to an embodiment of the present disclosure.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be made in the following order.

1. Summary of Information Processing Device according to the Present Disclosure

2. Each Embodiment
2-1. First Embodiment
2-2. Second Embodiment
2-3. Third Embodiment

3. Conclusion

### 1. Summary of Information Processing Device according to the Present Disclosure

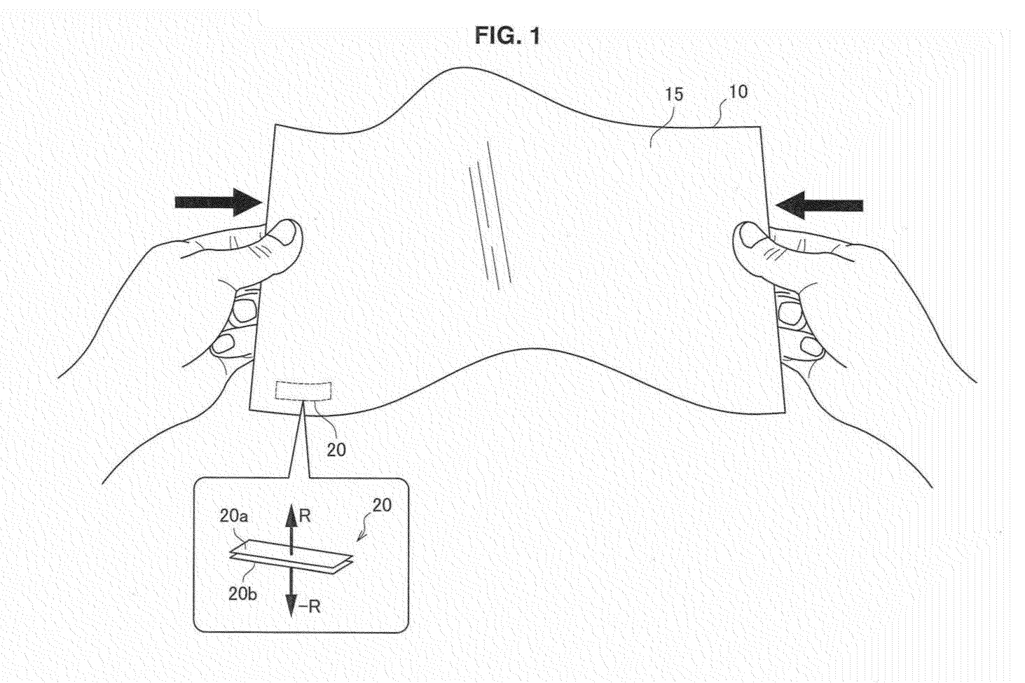

First, a summary of an information processing device according to the present disclosure will be described with reference to FIG. 1. FIG. 1 is an external view of an information processing device 10 according to the present disclosure. As shown in FIG. 1, the information processing device 10 according to the present disclosure is a flexible device made of soft materials, and is partially or entirely flexible. Consequently, a user can curve, locally fold, or roll up the entire information processing device 100. Note that in FIG. 1, the information processing device 10 is curved from right and left sides thereof as an example.

The information processing device 10 according to the present disclosure has a built-in curvature sensor (curve sensor) 20. The curvature sensor 20 has a structure in which curvature sensors 20a and 20b that can detect curve (deflection) in a single direction are attached. With the curvature sensor 20, curvature (the amount of curve) in the range of −R to R can be detected. Hereinafter, the configuration of the information processing device according to the present disclosure will be described with reference to the drawings.

### 1-1. Hardware Configuration

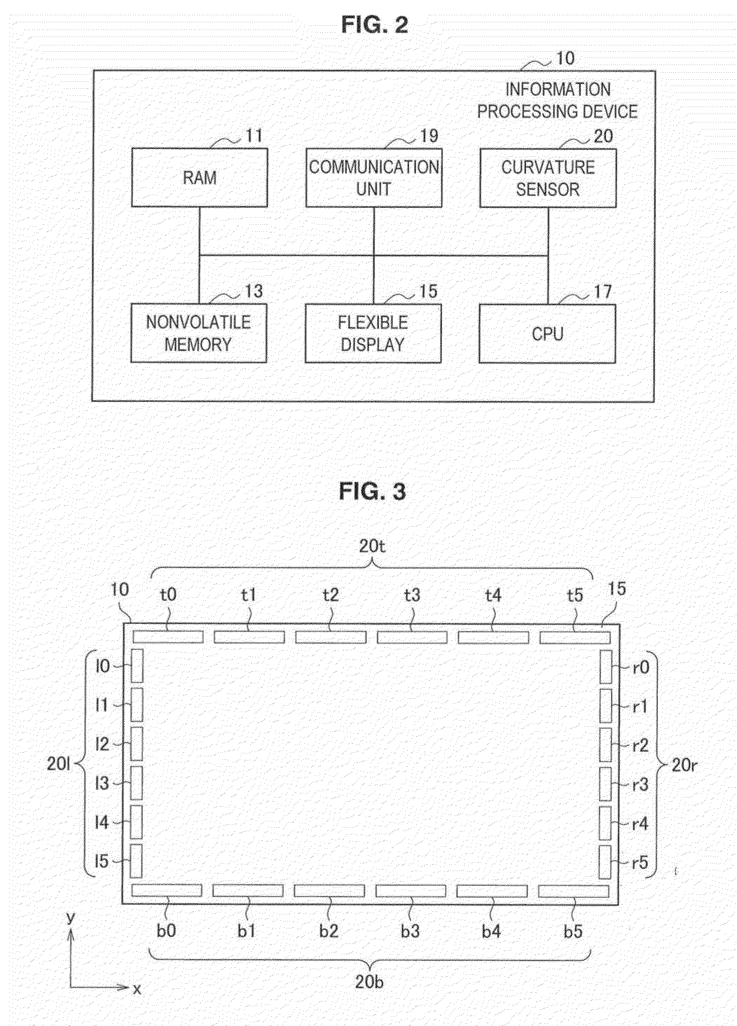

FIG. 2 is a diagram showing an exemplary hardware configuration of the information processing device 10 according to the present disclosure. As shown in FIG. 1, the information processing device 10 includes RAM (Random Access Memory) 11, nonvolatile memory 13, a flexible display 15, a CPU (Central Processing Unit) 17, a communication unit 19, and the curvature sensor 20. The CPU 17, the RAM 11, the nonvolatile memory 13, and the communication unit 19 may be formed of flexible materials and built in the information processing device 10 or be built in a rigid body unit (not shown) of the information processing device 10.

The CPU 17 functions as an arithmetic processing unit and a control unit, and controls the entire operation of the information processing device 10 according to various programs. The CPU 17 may also be a microprocessor.

The RAM 11 temporarily stores programs used in the execution of the CPU 17, parameters that change as appropriate during the execution, and the like. The nonvolatile memory 13 stores programs used by the CPU 17, operation parameters, and the like.

The communication unit 19 is a communication device that transmits and receives information to/from other communication devices or servers. The communication unit 19 performs short-range/proximity wireless communication such as Wi-Fi or Bluetooth, for example.

The flexible display 15 is an entirely flexible display device (display screen) formed of a flexible material. The flexible display 15 is controlled by the CPU 17 and displays an image screen.

The curvature sensor 20 is a sensor that can detect curvature (the amount of curve) in the range of −R to R when the information processing device 10 (the flexible display 15) is physically curved. In addition, the curvature sensor 20 outputs a resistance value as curvature, for example.

Further, the curvature sensor 20 according to the present disclosure is provided in a manner stacked on the flexible display 15 (the display screen). More specifically, one or more curvature sensors 20 may be provided on each side of the flexible display 15. Hereinafter, the arrangement of the curvature sensors 20 will be described with reference to FIG. 3.

### Arrangement of the Curvature Sensors 20

FIG. 3 is a diagram illustrating an exemplary arrangement of the curvature sensors 20 according to the present disclosure. As shown in FIG. 3, a plurality of curvature sensors 20 are arranged along each side of the flexible display 15. Specifically, as shown in FIG. 3, curvature sensors 20t (20t0 to 20t5) are arranged along the top side of the flexible display 15, and curvature sensors 20b (20b0 to 20b5) are arranged along the bottom side thereof. In addition, curvature sensors 20l (20l0 to 20l5) are arranged along the left side of the flexible display 15, and curvature sensors 20r (20r0 to 20r5) are arranged along the right side thereof.

As described above, the information processing device 10 according to the present disclosure has a plurality of curvature sensors 20 arranged on each of the four sides of the flexible display 15. Accordingly, the information processing device 10 can recognize the position of curve (xy directions) of the flexible display 15 on the basis of each of the curvatures detected from the curvature sensors 20.

The hardware configuration of the information processing device 10 according to the present disclosure has been described in detail above. Next, the function of the information processing device 10 implemented by the hardware configuration will be described.

### 1-2. Functional Configuration

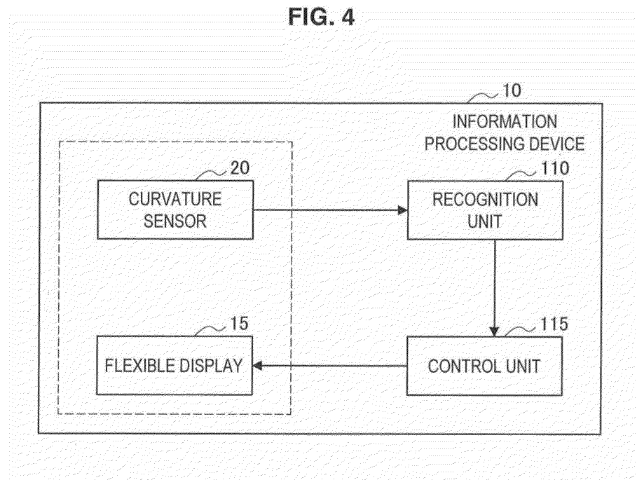

FIG. 4 is a functional block diagram illustrating the functional configuration of the information processing device 10 according to this embodiment. As shown in FIG. 4, the information processing device 10 includes a recognition unit 110 and a control unit 115. The recognition unit 110 recognizes the shape and the state of curve of the flexible display 15 on the basis of the curvature (the amount of curve/the amount of deflection) output from each curvature sensor 20. Specifically, the recognition unit 110 recognizes a temporal change (periodic change) in curvature as an operation input. In addition, the recognition unit 110 recognizes a center line of curve (a mountain fold portion or a fold center line) from the plurality of curvatures. Further, the recognition unit 110 recognizes if the flexible display 15 is in a rolled-up state on the basis of the curvatures. Then, the recognition unit 110 outputs the recognition result to the control unit 115.

The control unit 115, according to the recognition result obtained by the recognition unit 110, outputs a corresponding process command. Specifically, the control unit 115 performs control of switching the displayed content of the flexible display 15 or transmitting predetermined data according to a temporal change in curvature. In addition, the control unit 115 performs control of switching the displayed content of the flexible display 15 according to a center line of curve. Further, the control unit 15 performs predetermined display control or predetermined data conversion control when the flexible display 15 is in a rolled-up state.

The functional configuration of the information processing device 10 according to the present disclosure has been described above. Note that the details of the recognition unit 110 and the control unit 115 will be described in detail in the next <2. Each Embodiment> section.

### 2. Each Embodiment

### 2-1. First Embodiment

### Summary

As a method of inputting a user operation, there are known a method that uses an input device such as a keyboard or a mouse described above, and a gesture interface that uses an acceleration sensor. The gesture interface, however, has restrictions on its operation method as it is able to recognize shakes only in four directions (upward, downward, rightward, and leftward). In contrast, a flexible device having flexibility can be freely flexed (curved) in any direction (360°). Thus, if the state of deflection can be recognized, the degree of freedom of operability will significantly improve.

In addition, although JP 2010-157060A describes switching of the displayed content when the main body of a display device is physically distorted, by detecting the position in the XY directions and pressure in the Z direction, no mention is made of an operation that is input according to a change in curve.

Thus, according to the first embodiment of the present disclosure, a temporal change in the physically deflected state of the information processing device 10-1 is recognized as an operation input, and a corresponding process command is output. Thus, the convenience of inputting an operation by curving the device can be improved.

Hereinafter, a plurality of operation examples will be specifically described as examples of inputting an operation using a change in deflection according to this embodiment. Note that the hardware configuration and the functional configuration of the information processing device 10-1 according to this embodiment are as described in “1-1. Hardware Configuration” and “1-2. Functional Configuration.”

### Operation Example 1

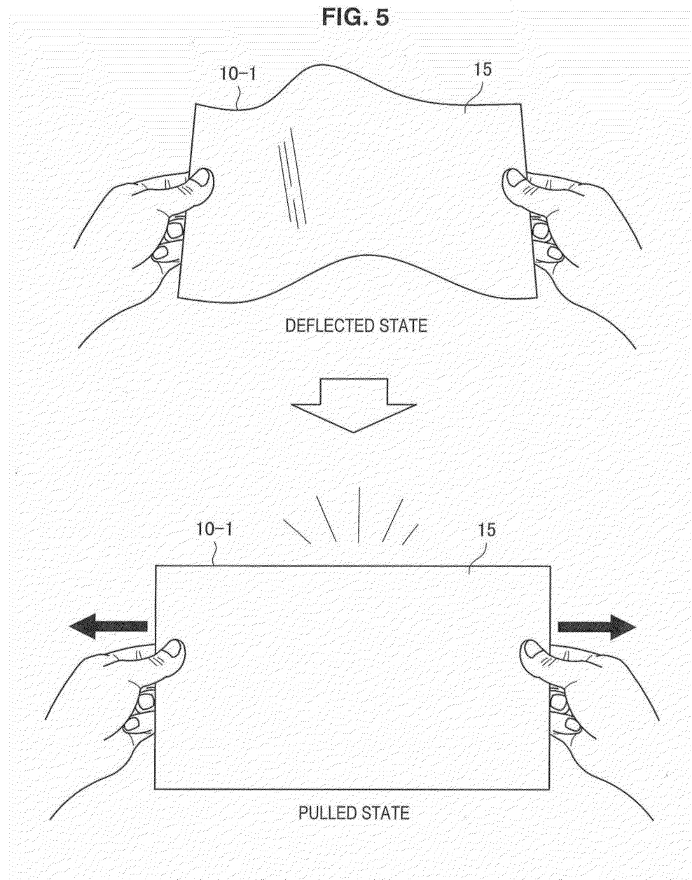

First, Operation Example 1 in which an operation is input using a change in deflection according to the first embodiment will be described with reference to FIGS. 5 to 8.

FIG. 5 is a diagram illustrating a basic operation of Operation Example 1 according to the first embodiment. As shown in FIG. 5, in Operation Example 1, an operation of rapidly changing the state of an information processing device 10-1 (the flexible display 15) from a deflected state to a pulled state is recognized as an operation input.

The deflected/pulled state of the flexible display 15 is recognized by the recognition unit 110 (see FIG. 4) on the basis of the curvatures detected from the curvature sensors 20. Hereinafter, the definition of each of the deflected state and the pulled state will be sequentially described.

As described with reference to FIG. 3, a plurality of curvature sensors 20 are provided along each of the four sides of the flexible display 15. Although FIG. 3 illustrates a configuration in which six curvature sensors 20 are provided on each side, that is, a total of 24 curvature sensors 20 are provided, the number of the curvature sensors 20 is not limited thereto. For example, a single curvature sensor may be provided on each side, that is, a total of four curvature sensors may be provided. This embodiment exemplarily describes a case where a total of N curvature sensors 20 are provided.

In this embodiment, N curvature sensors 20 are provided, and curvatures r₂, . . . r_{N} can be detected from the respective curvature sensors 20 in the following range.

−R≦rᵢ≦R (1≦i≦N)

At this time, the curvature r of the entire information processing device 10-1 (the flexible display 15) is defined as an average value of the values detected from the respective curvature sensors 20 as described below for example.

$$r = \frac{1}{N} {\sum }_{i = 1}^{N} {r}_{i}$$

In addition, a case where the curvature r of the entire information processing device 10-1 is in the range of Formula 2 or 3 below with respect to a threshold represented by Formula 1 below will be defined as a deflected state.

Rₜₕ (0≦Rₜₕ≦R) Formula 1

−R≦r≦−Rₜₕ Formula 2

Rₜₕ≦r≦R Formula 3

The definition of the deflected state has been described above. Meanwhile, the definition of the pulled state is a case where the information processing device 10-1 is not in the deflected state. Specifically, the information processing device 10-1 may be determined to be in the pulled state if the curvature r of the entire information processing device 10-1 is in the range of Formula 4 below.

−Rₜₕ<r<Rₜₕ Formula 4

The recognition unit 110 can determine the state of the information processing device 10-1 (the flexible display 15) according to the aforementioned definitions of the deflected/pulled states. Further, the recognition unit 110 recognizes that an operation is input when the speed at which the information processing device 10-1 changes state from the deflected state to the pulled state is greater than or equal to a predetermined speed. Note that when the information processing device 10-1 has an acceleration sensor, the recognition unit 110 may recognize that an operation is input if the acceleration detected when the information processing device 10-1 changes state from the deflected state to the pulled state is greater than or equal to a predetermined acceleration (a rapid change).

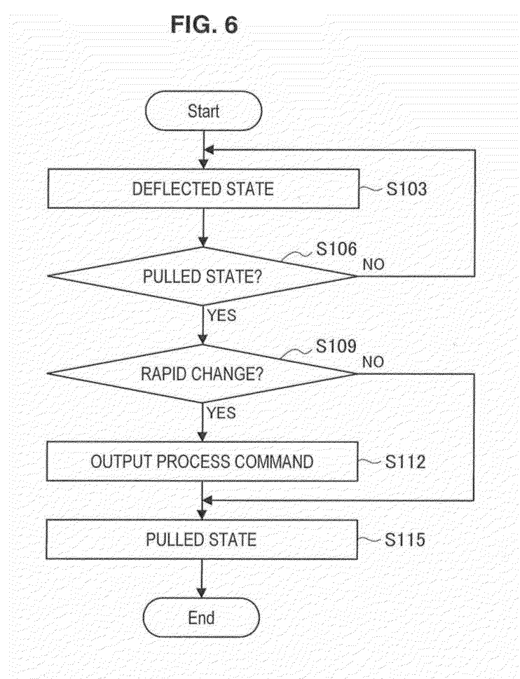

Next, an operation process of Operation Example 1 above will be described with reference to FIG. 6. FIG. 6 is a flowchart showing an operation process of Operation Example 1 according to the first embodiment. As shown in FIG. 6, first, in step S103, the recognition unit 110 recognizes that the information processing device 10-1 (the flexible display 15) is in the deflected state on the basis of the curvature r detected from the curvature sensor 20.

Next, in step S106, the recognition unit 110 recognizes that the information processing device 10-1 is in the pulled state on the basis of the curvature r detected from the curvature sensor 20.

Next, in step S109, the recognition unit 110 determines if the speed at which the information processing device 10-1 changes state from the deflected state to the pulled state is a rapid change.

Next, in step S112, it is determined that if a change in state from the deflected state to the pulled state is a rapid change. If there has been a rapid change can be determined from, for example, if the speed of change is greater than or equal to a predetermine speed. Then, the recognition unit 110, if the change in state from the deflected state to the pulled state is a rapid change, recognizes the change as an operation input, and outputs the recognition result to the control unit 115.

Next, in step S112, the control unit 115, according to the recognition result obtained by the recognition unit 110, outputs a process command corresponding to the operation input effected by a rapid change in state from the deflected state to the pulled state. Then, in step S115, the output process command is executed in the information processing device 10-1 in the pulled state.

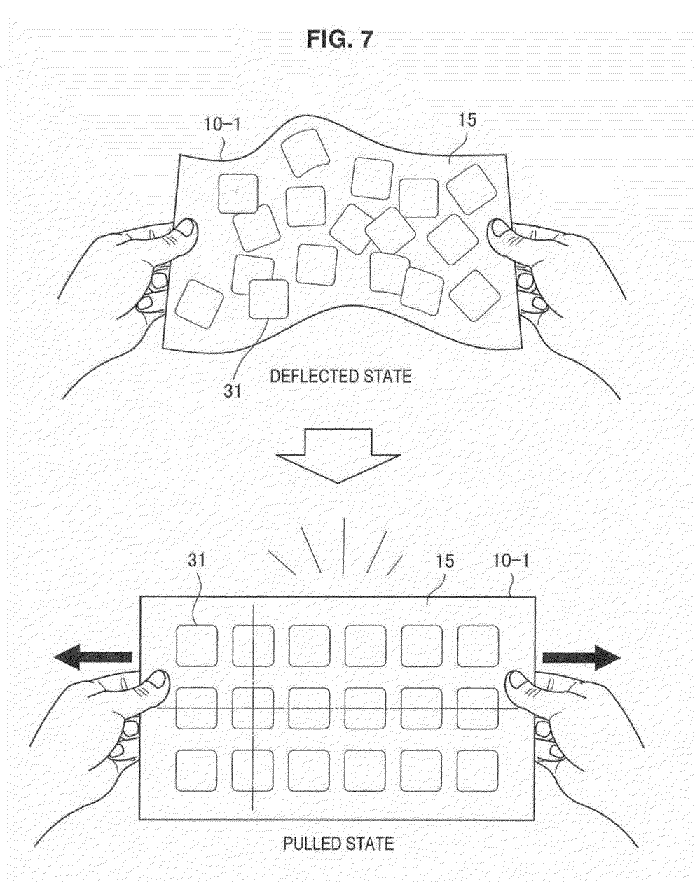

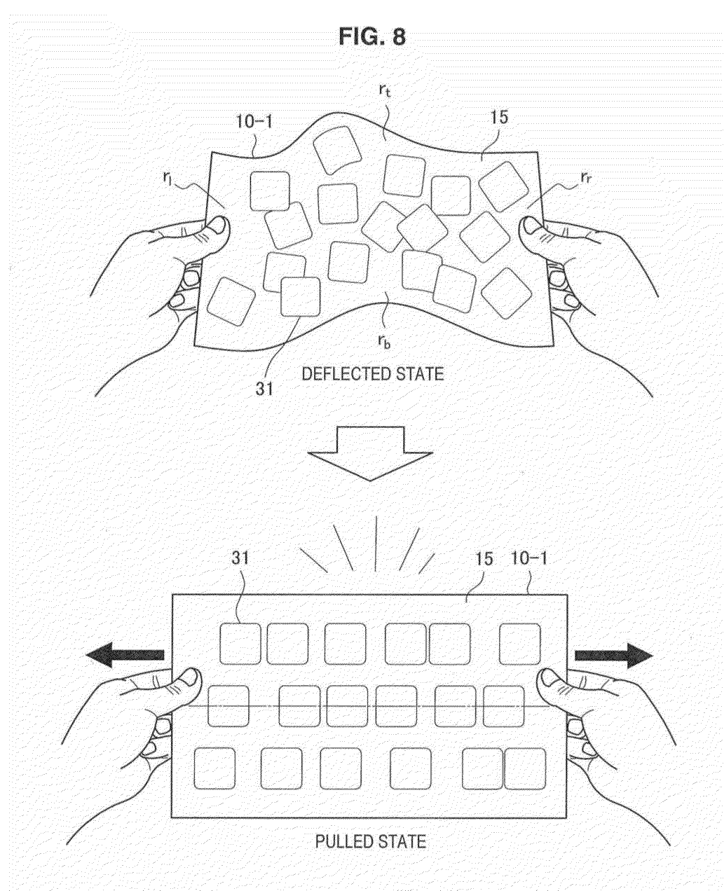

The operation process of Operation Example 1 has been described in detail above. A process command output from the control unit 115 in step S112 above is not particularly limited, and it may be a process command that makes a user feel intuitively that the process command is related to an operation of rapidly changing the state from the deflected state to the pulled state, for example. The operation of rapidly changing the state from the deflected state to the pulled state is similar to a sense of operation of “unfolding and fixing a newspaper” for the user. Thus, by executing a process command of fixing the displayed content on the basis of such sense of operation, it becomes possible to realize an intuitive operation input. Hereinafter, description will be specifically made with reference to FIGS. 7 and 8.

FIG. 7 is a diagram illustrating an automatic alignment command in Operation Example 1 according to the first embodiment. As shown in the upper view in FIG. 7, when icons 31 are displayed irregularly on the flexible display 15, the control unit 115, upon receiving an input of an operation of rapidly changing the state of the flexile display 15 from the deflected state to the pulled state, outputs an automatic alignment command. Then, as shown in the lower view in FIG. 7, the icons 31 are automatically aligned in the vertical direction and the horizontal direction.

The information processing device 10-1 according to this embodiment may also realize automatic alignment according to the pulled direction. FIG. 8 is a diagram illustrating an automatic alignment command according to the pulled direction in Operation Example 1 according to the first embodiment. As shown in FIG. 8, the control unit 115, when the recognition unit 110 recognizes that the flexible display 15 is pulled in the horizontal direction, outputs a process command of aligning the icons 31 in the horizontal direction.

The determination of the pulled direction by the recognition unit 110 may be performed by, for example, extracting each of the curvature rₜ of the top side, the curvature r_{b} of the bottom side, the curvature rₗ of the left side, and the curvature rᵣ of the right side of the flexible display 15 and selecting the two smallest curvatures. In the example shown in FIG. 8, the curvature rₗ of the left side and the curvature rᵣ of the right side can be selected as the two smallest curvatures. Thus, the recognition unit 110 can determine that the flexible display 15 is pulled in the horizontal direction. Then, the recognition unit 110 recognizes that an operation of rapidly pulling the flexible display 15 in the horizontal direction is input and outputs the recognition result to the control unit 115.

As described above, according to Operation Example 1 of the first embodiment, it is not necessary to select an icon alignment command from a menu. Thus, by rapidly pulling the flexible display in the physically deflected state toward opposite sides, it becomes possible to realize intuitive automatic icon alignment.

### Operation Example 2

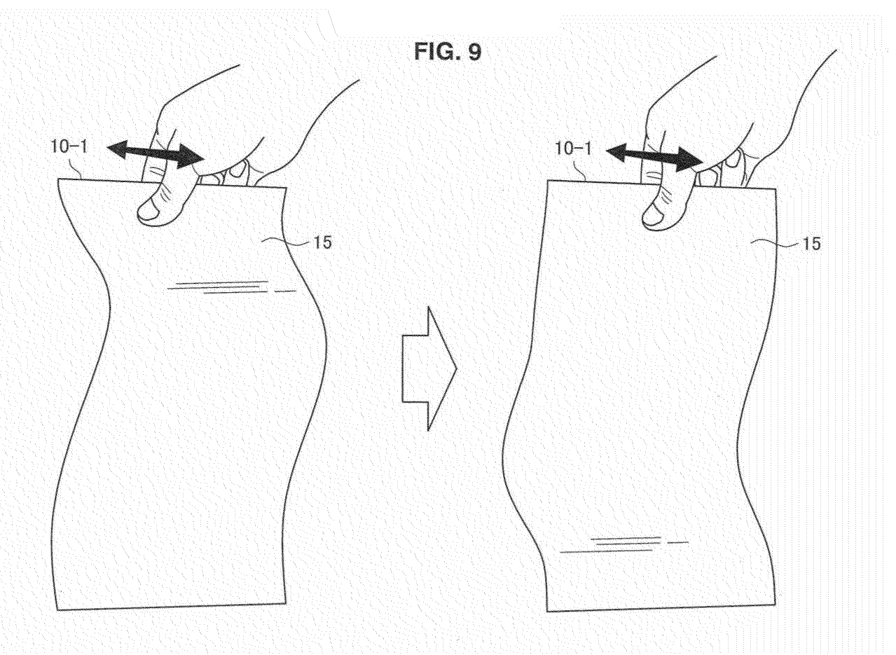

Next, Operation Example 2 will be described in which an operation is input utilizing a change in deflection according to the first embodiment will be described with reference to FIG. 9 to FIG. 14.

FIG. 9 is a diagram illustrating a basic operation of Operation Example 2 according to the first embodiment. As shown in FIG. 9, in Operation Example 2, when the information processing device 10-1 (the flexible display 15) is moved back and forth with the lower end thereof being held, an operation of deflecting the information processing device 10-1, that is, a shake operation is recognized as an operation input.

The shake operation is recognized by the recognition unit 110 (see FIG. 4) on the basis of the curvature detected from the curvature sensor 20. Specifically, the recognition unit 110, when a temporal change r(t) in curvature r of the entire information processing device 10-1 is periodic, recognizes that an operation is input through a shake operation.

The method of determining if the temporal change in curvature is periodic may be, for example, a method of determining a cross-correlation value of the temporal change r in curvature r(t) and the sine function sin(t) through Fourier transform and determining if the cross-correlation value is greater than or equal to a predetermined threshold.

Note that the recognition unit 110 can, by adding a recognition condition for recognizing an operation input effected by a shake operation, increase the recognition accuracy for the shake operation. In addition, by increasing the recognition accuracy for the shake operation as described above, it becomes possible to finely set a corresponding process command and thus realize a more intuitive operation input.

The recognition condition to be added may be, for example, that a user should hold one point of the information processing device 10-1 (the flexible display 15). Specifically, in the configuration in which the information processing device 10-1 has a touch panel, the touch panel detects a position held by the user. Then, the recognition unit 110, when a shake operation is performed while only one point is held, recognizes that an operation is input.

Alternatively, it is also possible to provide a severer recognition condition such that a user should hold only the upper end of the information processing device 10-1 (the flexible display 15). Specifically; in the configuration in which the information processing device 10-1 has a triaxial accelerometer in addition to a touch panel, the triaxial accelerometer detects the orientation of the information processing device 10-1 with respect to the gravity direction. Then, the recognition unit 110, when it can be determined that a shake operation is performed while only the upper end of the information processing device 10-1 is held on the basis of the orientation of the information processing device 10-1 and the position held by the user, recognizes that an operation is input.

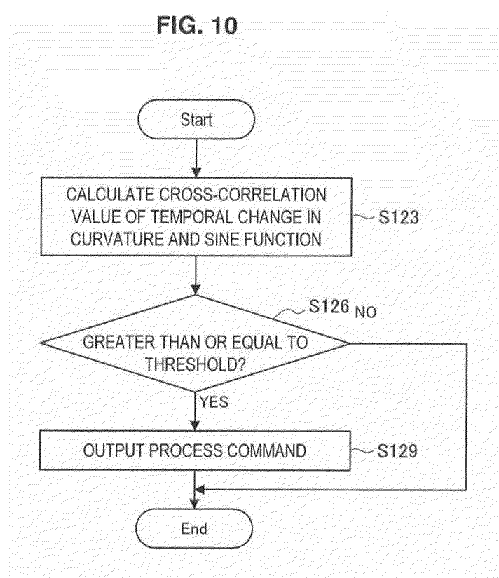

Next, an operation process of Operation Example 2 above will be described with reference to FIG. 10. FIG. 10 is a flowchart showing an operation process of Operation Example 2 according to the first embodiment. As shown in FIG. 10, first, in step S123, the recognition unit 110 calculates a cross-correlation value of the temporal change r in curvature r(t) and the sine function sin(t) in step S123.

Next, in step S126, the recognition unit 110 determines if the calculated cross-correlation value is greater than or equal to a predetermined threshold. If the cross-correlation value is greater than or equal to a predetermined threshold, it is determined that the temporal change in curvature is periodic, and the recognition unit 110 outputs to the control unit 115 information to the effect that a shake operation is recognized as an operation input, as a recognition result.

Then, in step S129, the control unit 115 outputs a process command corresponding to the operation input effected by the shake operation according to the recognition result of the recognition unit 110.

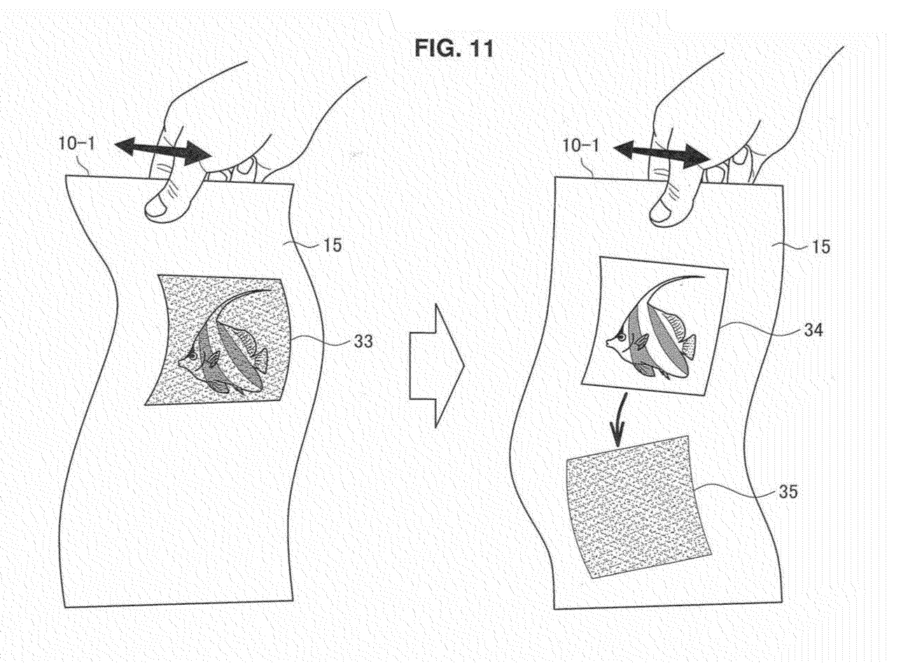

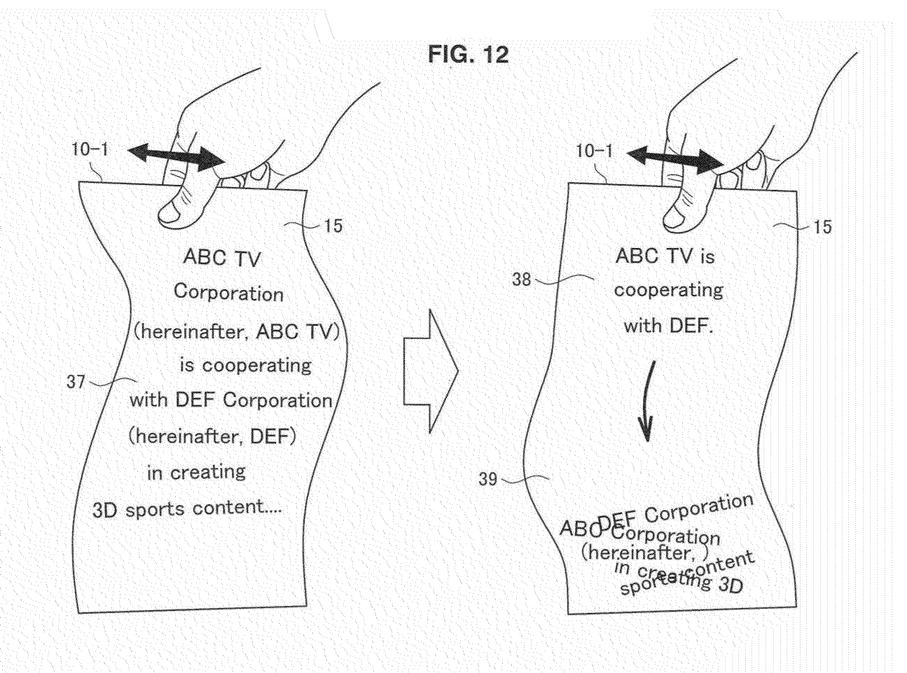

The operation process of Operation Example 2 has been described in detail above. The process command that the control unit 115 outputs in step S129 above is not particularly limited, and it may be a process command that makes a user feel intuitively that the process command is related to a shake operation, for example. The shake operation is similar to a sense of operation of “shaking off dust from the paper surface” for the user. Thus, by executing a process command of removing noise on the basis of such sense of operation, it becomes possible to realize an intuitive operation input. Hereinafter, a specific example will be described with reference to FIGS. 11 and 12.

FIG. 11 is a diagram illustrating a noise removing command in Operation Example 2 according to the first embodiment. As shown in left view in FIG. 11, when an image 33 containing noise is displayed, the control unit 115, upon receiving an input of an operation of shaking the information processing device 10-1, outputs a noise removing command. Then, as shown in the right view in FIG. 11, an image 34 after removal of noise and noise 35 are displayed, and the noise 35 is display-controlled such that it falls downward.

In a addition, the information processing device 10-1 according to this embodiment may regard an unnecessary portion of text as noise and realize a process of summarizing a text according to a shake operation. An unnecessary portion of a text may be, for example, when a text is segmented into clauses, parts other than clauses having subject-predicate relationship or, when a text includes a main clause and a conjunctive clause, the conjunctive clause. Alternatively; when a text includes both a formal name and an abbreviation, the formal name may be regarded as an unnecessary portion.

FIG. 12 is a diagram illustrating a text summarizing command according to a shake operation in Operation Example 2 according to the first embodiment. As shown in the left view in FIG. 12, when a text 37 is displayed, the control unit 115, upon receiving an input of an operation of shaking the information processing device 10-1, regards an unnecessary portion of the text 37 as noise and outputs a command for summarizing the text by removing the noise.

Then, as shown in the right view in FIG. 12, a text 38 after the summarizing process and noise 39 determined to be an unnecessary portion and deleted from the text 37 are displayed, and the noise 39 is display-controlled such that it falls downward.

Hereinabove, a case where a process command of removing noise is executed has been described specifically. Note that the information processing device 10-1 according to this embodiment may change the intensity of noise removal according to the duration of the shake operation or the number of repetitions of the shake operations.

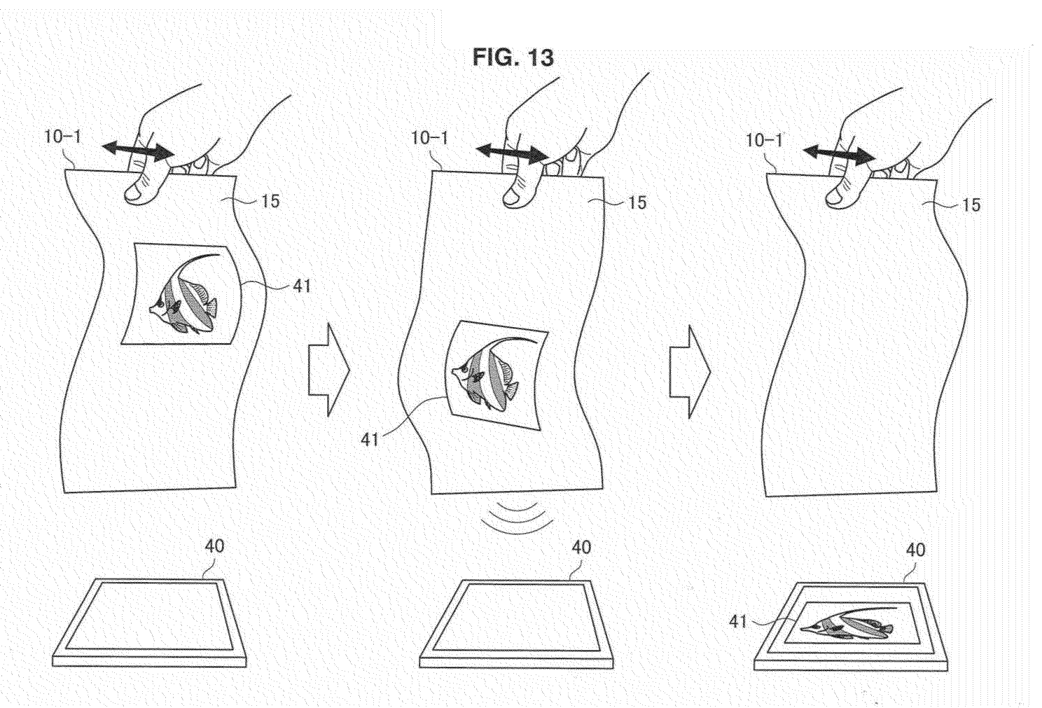

In addition, a shake operation is similar to a sense of operation of “dropping an object inside” for the user. Accordingly, it is also possible to execute a data transfer command on the basis of such sense of operation to realize an intuitive operation input. Hereinafter, specific description will be made with reference to FIG. 13.

FIG. 13 is a diagram illustrating a data transfer command in Operation Example 2 according to the first embodiment. As shown in the left view in FIG. 13, the control unit 115, upon receiving an input of an operation of shaking the information processing device 10-1 when an image 41 is displayed, outputs a command to transfer the image 41 to a nearby communication device 40.

Next, as shown in the middle view in FIG. 13, on the flexible display 15 of the information processing device 10-1, the photographic image 41 is displayed such that it falls downward, and at the same time, the communication unit 19 transmits the image 41 to the communication device 40. Then, when the transmission by the communication unit 19 is completed, completion of the transfer can be explicitly shown for the user by putting the image 41 into a non-display state on the flexible display 15 of the information processing device 10-1 as shown in the right view in FIG. 13.

As described above, according to Operation Example 2 in the first embodiment, a noise removing command need not be selected from a menu, and it is thus possible to intuitively realize removal of noise from an image or a text by physically shaking the flexible display. In addition, according to Operation Example 2 in the first embodiment, a data transfer command need not be selected from a menu, and it is thus possible to intuitively realize data transfer by physically shaking the flexible display.

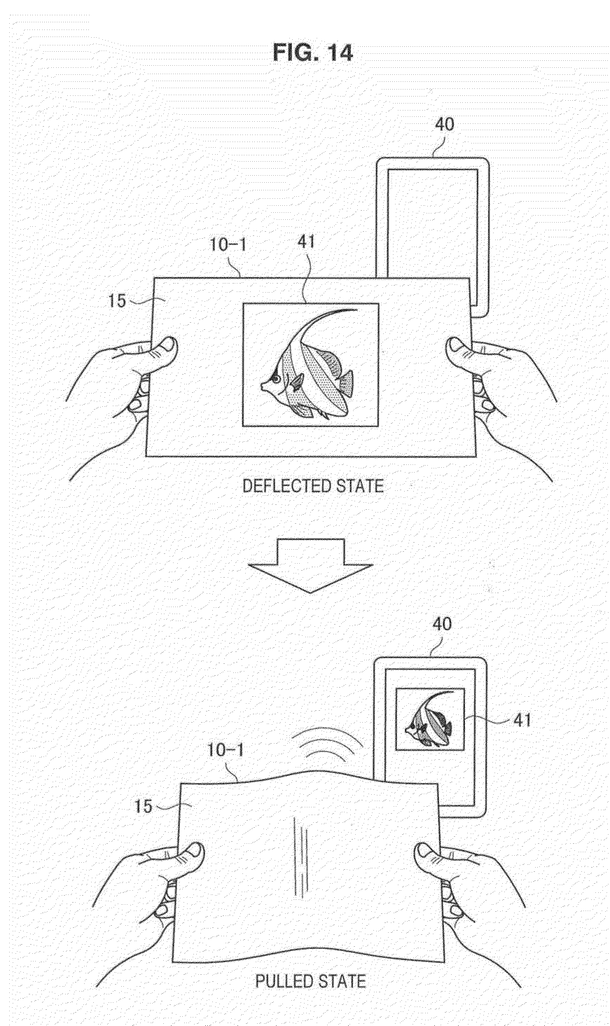

Although Operation Example 1 described above illustrates an example in which a rapid change in state from the deflected state to the pulled state is recognized as an operation input, the operation example according to this embodiment is not limited thereto. For example, a rapid change in state from the pulled state to the deflected state may be recognized as an operation input. Further, data transfer may be performed as a process command corresponding to an operation input effected by a rapid change in state from the pulled state to the deflected state. Hereinafter, specific description will be made with reference to FIG. 14.

FIG. 14 is a diagram illustrating a data transfer command according to a variation of the first embodiment. As shown in the upper view in FIG. 14, when the information processing device 10-1, in the pulled state and the image 41 is displayed on the flexible display 15, a user may input an operation of rapidly deflecting the information processing device 10-1 toward the communication terminal 40 as shown in the lower view in FIG. 14. Accordingly, the control unit 115 outputs a command of transferring the image 41 to the nearby communication device 40, and the communication unit 19 transmits the image 41 to the communication device 40. In addition, when transmission by the communication unit 19 is completed, completion of the transfer can be explicitly indicated for the user by putting the image 41 into a non-display state on the flexible display 15.

As described above, according to the first embodiment of the present disclosure, it is possible to, by recognizing a temporal change in deflection when the information processing device 10-1 is physically deflected as an operation input and outputting a corresponding process command, increase the convenience of inputting an operation by curving the device. In addition, it is also possible to, by outputting a process command that makes a user feel intuitively that the process command is related to a change in deflection, realize an intuitive operation input.

### 2-2. Second Embodiment

### Summary

Next, a second embodiment according to the present disclosure will be described. As described above, when an operation input is realized by physically curving a flexible device having flexibility, the input operation (the amount of curve) in the Z direction is detected with a pressure sensor or the like, and the input position (the position of curve) in the XY directions is detected with a position sensor or the like (see JP 2010-157060A). However, a structure having such a plurality of types of special sensors (detection units) is costly. In addition, with a position sensor that is typically used, it is able to recognize only a local position and it is thus difficult to grasp a linear folded position (the position of curve) or the like.

Further, with a sensor that detects an input operation the Z direction such as a pressure sensor or a distortion sensor, it is typically possible to output only the amount of a single curve (deflection) from a single sensor, and it is difficult to detect the position of deflection.

According to the second embodiment of the present disclosure, it is possible to, by arranging a plurality of deflection detection units (curvature sensors), recognize the amount of deflection (the amount of curve) and the position of deflection (the position of curve) on the basis of each of the detection results obtained by the plurality of deflection detection units, and further recognize the state of deflection (the state of curve). Then, according to the second embodiment of the present disclosure, the thus recognized state of curve is recognized as an operation input, and a corresponding process command is output.

The summary of the second embodiment according to the present disclosure has been described above. Note that the hardware configuration and the functional configuration of the information processing device 10-2 that realizes an operation input according to the state of curve according to this embodiment are as described above. Next, recognition of the state of curve using a plurality of deflection detection units 20 according to this embodiment will be described.

### Recognition of the State of Curve

The recognition unit 110 according to the second embodiment (sec FIG. 4) recognizes the state of curve on the basis of curvatures (hereinafter also referred to as amounts of curve) detected from the plurality of curvature sensors 20. The plurality of curvature sensors 20 are arranged such that as shown in FIG. 3, a plurality of curvature sensors 20t are arranged on the top-side array of the flexible display 15, a plurality of curvature sensors 20b are arranged on the bottom-side array, a plurality of curvature sensors 2l1 are arranged on the left-side array; and a plurality of curvature sensors 20r are arranged on the right-side array.

In such a configuration, the recognition unit 110 according to this embodiment recognizes the state of curve of the information processing device 10-2 on the basis of each of the detection results output from the plurality of curvature sensors 20. More specifically, for example, the recognition unit 110 checks a signal sequence including each of the detection results output from the plurality of curvature sensors 20 against the actual physical arrangement of the curvature sensors 20. Accordingly, the recognition unit 110 can measure how large the amount of curve is at each position of the information processing device 10-2, and consequently can recognize the state of curve of the information processing device 10-2. In addition, the recognition unit 110 can increase the recognition accuracy for the state of curve by interpolating data in the signal sequence.

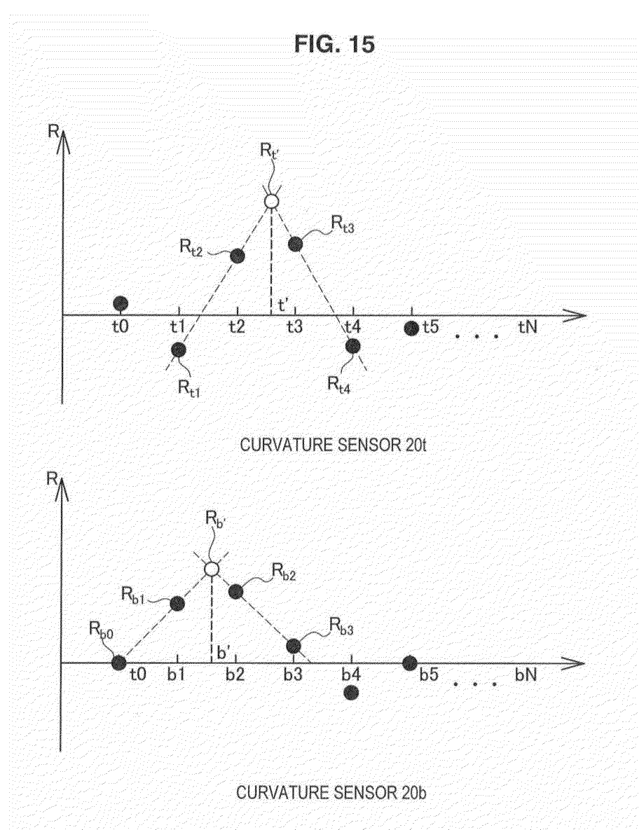

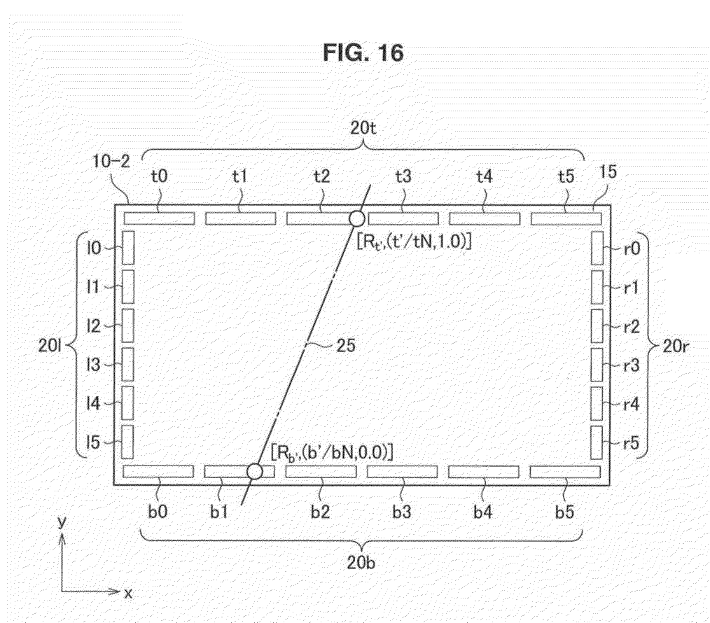

In addition, the recognition unit 110 according to this embodiment may, for a signal sequence of the sensors (the curvature sensors 20t, 20b, 20l, and 20r) on the respective arrays, estimate center points of curve and recognize a line connecting the center points of curve on opposite sides as a center line of the curve. Alternatively, the recognition unit 110 may recognize a line obtained by perpendicularly extending a line from a center point of curve on a single side toward its opposite side as a center line of the curve. Hereinafter, a case where a line connecting center points of curve on opposite sides is recognized as a center line of the curve will be specifically described with reference to FIGS. 15 and 16.

FIG. 15 is a diagram showing, in the information processing device 10-2 according to the second embodiment, a signal sequence including the amounts of curve detected from the curvature sensor 20t provided on the top side of the flexible display 15 and the curvature sensor 20b provided on the bottom side thereof. Note that FIG. 15 is based on a state in which, as shown in FIG. 1, a user holds the right and left sides of the flexible display 15 by hands and physically curves the flexible display 15 by moving each hand toward the center. Thus, each of the detection results (the amount of curve) obtained by the curvature sensor 20l on the left side and the curvature sensor 20r on the right side whose amounts of curve are substantially close to zero will be omitted.

The recognition unit 110 first determines a center point of curve on each side on the basis of the amount of curve from each curvature sensor 20. Specifically, as shown in the upper view in FIG. 15, the recognition unit 110 extracts two maximum amounts of curve Rₜ₂ and Rₜ₃ from the curvature sensors 20t0 to 20tN arranged on the top side, and estimates a position t′ of the center point and the amount of curve at that position from the amounts of curve Rₜ₁ and R₁₄ that are adjacent to the maximum values. In addition, as shown in the lower view in FIG. 15, the recognition unit 110 extracts two maximum amounts of curve R_{b1} and R_{b2} from the curvature sensors 20b0 to 20bN arranged on the bottom side, and estimates a position b′ of the center point and the amount of curve Rb′ at that position from the amounts of curve R_{b0} and R_{b3} that are adjacent to the maximum values.

FIG. 16 is a diagram illustrating recognition of a center line of curve according to the second embodiment. As shown in FIG. 16, the recognition unit 110 recognizes as a center line 25 of curve a line connecting the coordinates (t′/tN, 1.0) of the position of a center point of curve on the top side of the information processing device 10-2 and the coordinates (b′/bN, 0.0) of the position of a center point of curve on the bottom side. In addition, FIG. 16 also shows the amounts of curve R_{t′}, and R_{b′} at the coordinates of the positions of the center points of curve.

Although FIG. 15 and FIG. 16 each show an example in which center points of curve are estimated first, and then a line connecting the center points of curve on the opposite sides is recognized as a center line of the curve, recognition of a center line of curve according to this embodiment is not limited thereto. For example, the recognition unit 110 may first estimate the stereoscopic shape of the information processing device 10-2 that is physically curved, from the amount of curve obtained by each curvature sensor 20, and then recognize a center line of the curve.

Recognition of the state of curve according to this embodiment has been described specifically. The control unit 115 according to this embodiment, on the basis of the state of curve recognized by the recognition unit 110 as described above, outputs a corresponding process command. The process command output from the control unit 115 is not particularly limited, and it may be, for example, a process command that makes a user feel intuitively that the process command is related to a curving operation performed by the user.

For example, the operation of curving the information processing device 10-2 from opposite sides thereof is similar to a sense of focusing on the position of curve. When enlarging display control is executed on the basis of such sense of operation, it becomes possible to realize an intuitive operation input.

In addition, the operation of folding the information processing device 10-2 is similar to, for example, a sense of bookmarking or a sense of flipping a page. Thus, by executing a bookmark function or control of displaying a next page according to such sense of operation, it becomes possible to realize an intuitive operation input.

As described above, various combinations of the states of curve and corresponding process commands can be considered. Hereinafter, control performed by the control unit 115 of this embodiment according to the state of curve will be specifically described with reference to a plurality of examples.

### Display Control Example 1

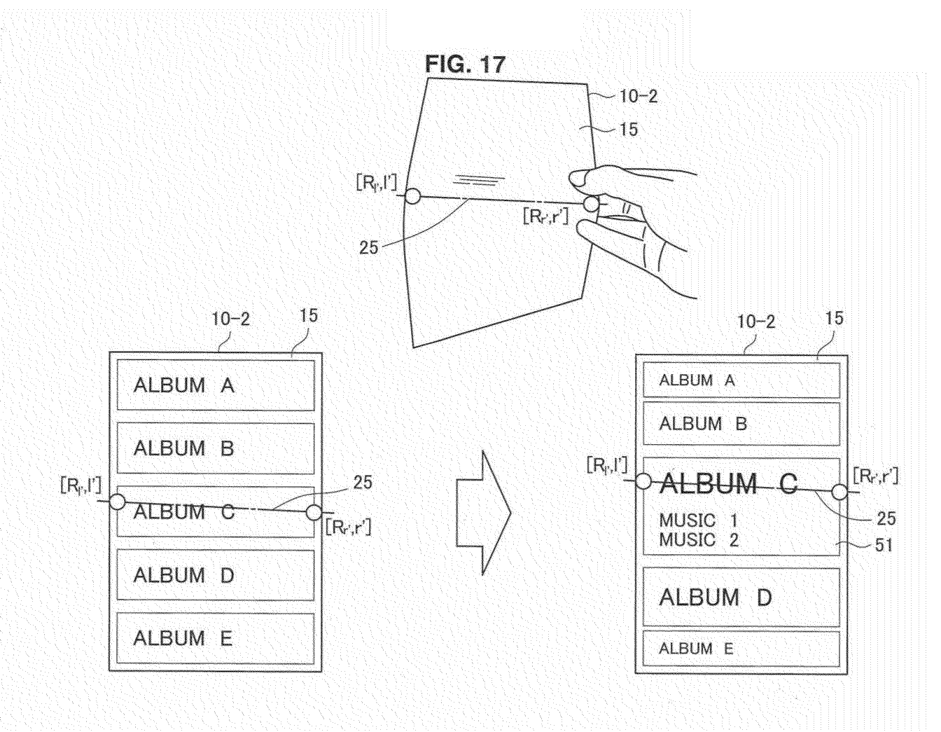

In Display Control Example 1 according to the second embodiment, the control unit 115 enlarges/shrinks the displayed content according to a center line 25 of curve recognized by the recognition unit 110. Hereinafter, specific description will be made with reference to FIGS. 17 to 20.

List Item Enlarging/Shrinking Display Control

FIG. 17 is a diagram illustrating display control of enlarging a list item according to a center line 25 of curve in Display Control Example 1 according to the second embodiment. As shown in the upper view in FIG. 17, when the information processing device 10-2 is pushed with a finger from its rear side and is curved in the lateral direction (substantially horizontal direction), a center line 25 of curve connecting the center position l′ of curve on the left side and a center position r′ of curve on the right side is recognized by the recognition unit 110. Then, the recognition unit 110, if the amount of curve R_{l′}, R_{r′} at each center position is greater than or equal to a predetermined threshold, recognizes that a curving operation is input, and executes corresponding display control. For example, the control unit 115 performs display control of enlarging a display portion corresponding to the position of the center line 25 of curve.

In the example shown in the lower view of FIG. 17, album names A to E are displayed as list items on the flexible display 15. Thus, the control unit 15 performs display of enlarging an “ALBUM C” that is a list item corresponding to the position of the center line 25 of curve. Accordingly, it becomes possible to represent that the “ALBUM C” is focused. In addition, the control unit 115 may also display information on list items within an area 51 of the enlarged “ALBUM C.” For example, when list items are album names, names of music pieces may be displayed as information on the list items.

The control unit 115 may also control the amount of information within an area of an enlarged list item according to the amount of curve R′. Note that the amount of curve R′ may be the sum or the average value of the amounts of curve R′ at the center positions of curve on opposite sides (the amounts of curve R_{l′} and R_{r′} in the example shown in FIG. 17).

In addition, the control unit 15 may also perform display control of shrinking (attenuating) list items around the enlarge-displayed list item.

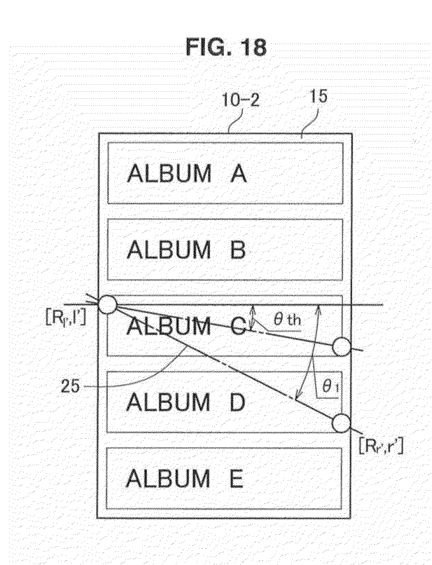

Further, the control unit 115 may discard an input of a curving operation depending on the angle θ of the center line 25 of curve with respect to the information processing device 10-2. For example, as shown in FIG. 18, when the angle θ₁ of the center line 25 of curve with respect to the information processing device 10-2 is greater than or equal to a threshold θₜₕ, the control unit 115 discards the input of the curving operation.

Display Control of Enlarging/Shrinking Document

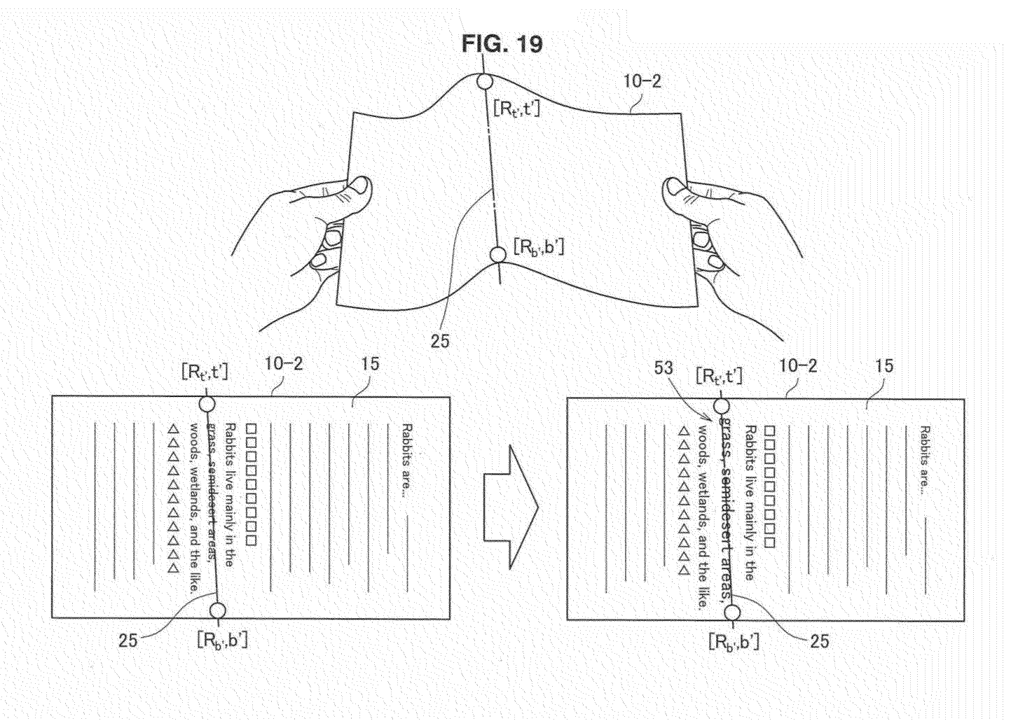

Although FIGS. 17 and 18 exemplarily show display control of enlarging/shrinking list items, the target of the enlarging/shrinking display control in Display Control Example 1 is not limited to the list items. For example, documents may be subjected to enlarging/shrinking display control. Hereinafter, display control of enlarging/shrinking a document will be specifically described with reference to FIG. 19.

FIG. 19 is a diagram illustrating display control of enlarging a text according to a center line 25 of curve in Display Control Example 1 according to the second embodiment. As shown in the upper view in FIG. 19, when the information processing device 10-2 is curved from right and left sides thereof, a center line 25 of curve connecting a center position t′ of curve on the top side and a center position b′ of curve on the bottom side is recognized by the recognition unit 110. Then, the recognition unit 110, when the amount of curve R_{t′}, R_{b′} at each center position is greater than or equal to a predetermined threshold, recognizes that a curving operation is input, and executes corresponding display control. For example, the control unit 115 performs display control of enlarging a display portion corresponding to the position of the center line 25 of curve.

Herein, as shown in the lower view in FIG. 19, a text is displayed on the flexible display 15. Thus, the control unit 15 performs display of enlarging a text on a line corresponding to the position of the center line 25 of curve. Accordingly, it is possible to express that line 53 is focused. In addition, the control unit 115 may also perform display control of shrinking (attenuating) texts on lines around line 53 that is enlarged.

As described above, the control unit 115 may perform control of displaying a text on a line close to the center line 25 of curve in larger size (enlarging display control) and control of displaying texts on lines around the center line 25 of curve in smaller size (attenuation display control). Note that the enlargement factor and the reduction factor (peripheral attenuation factor) may also be changed according to the amount of curve R′ (determined on the basis of the amounts of curve R_{t′} and R_{b′} in the example shown in FIG. 19).

Display Control of Enlarging/Shrinking Content according to Change in Center Line of Curve

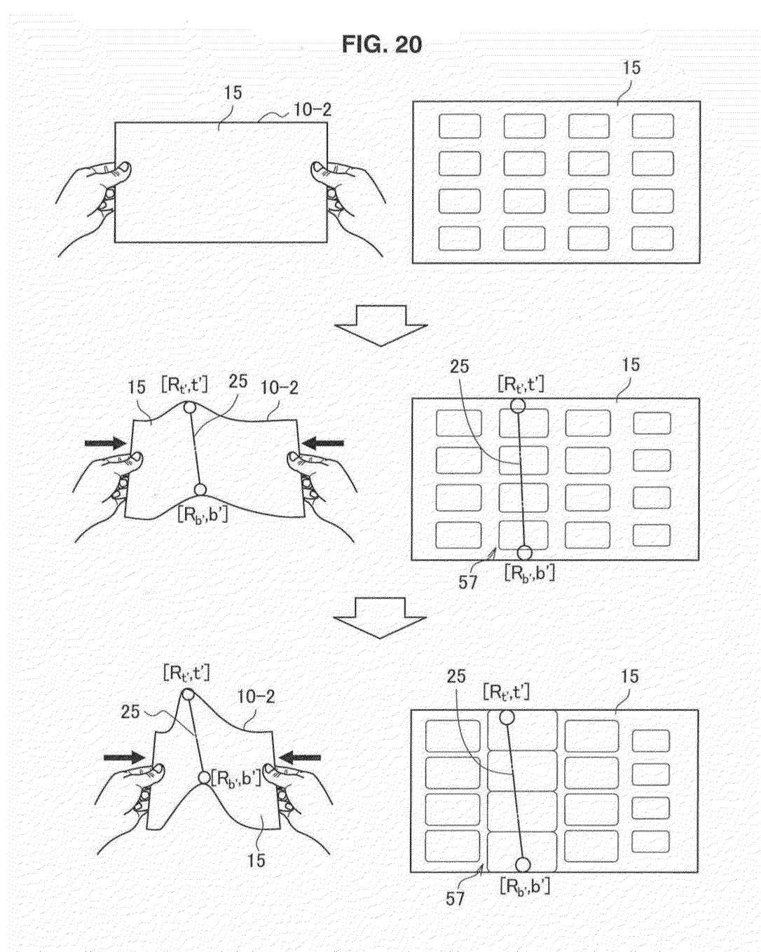

Display control of enlarging/shrinking a display portion corresponding to the position of the center line 25 of curve has been specifically described with reference to FIGS. 17 to 19 above. The control unit 115 according to this embodiment may dynamically perform display control of enlarging/shrinking content according to the center line 25 of curve as described above according to a change in the center line 25 of curve. Herein, content (objects) are, for example, tile graphics of a GUI (Graphical User Interface) typified by icons or thumbnail lists, GUI lists arranged in a single direction, and text information. Hereinafter, display control of dynamically enlarging/shrinking content will be specifically described with reference to FIG. 20.

FIG. 20 is a diagram illustrating dynamic enlarging display control performed according to change in a center line 25 of curve in Display Control Example 1 according to the second embodiment. As shown in the left view in FIG. 20, when the information processing device 10-2 is gradually curved from right and left sides thereof, the position of the center line 25 of curve and the amount of curve R′ (which can be determined from the amounts of curve Rt′ and Rb′ in the example shown in FIG. 20) change. Then, the recognition unit 110 controls the display information of the flexile display 15 according to the changes in the position of the center line of curve and the amount of curve R.

In the example shown in the left view in FIG. 20, when the information processing device 10-2 is gradually curved from right and left sides thereof, the amount of curve R′ of the center line 25 of curve gradually increases. The control unit 115, according to such a change in the amount of curve R′, performs display control of gradually enlarging content 57 at a position close to the center line 25 of curve. In addition, the control unit 115 may also perform display control of shrinking (attenuating) the content around the enlarged content 57.

As described above, the control unit 115 may perform control of displaying content at a position close to the center line 25 of curve in larger size (enlarging display control) and control of displaying text around the center line 25 of curve in smaller size (attenuation display control). Note that the enlargement factor and the reduction factor (peripheral attenuation factor) may be changed according to the amount of curve R′.

### Display Control Example 2

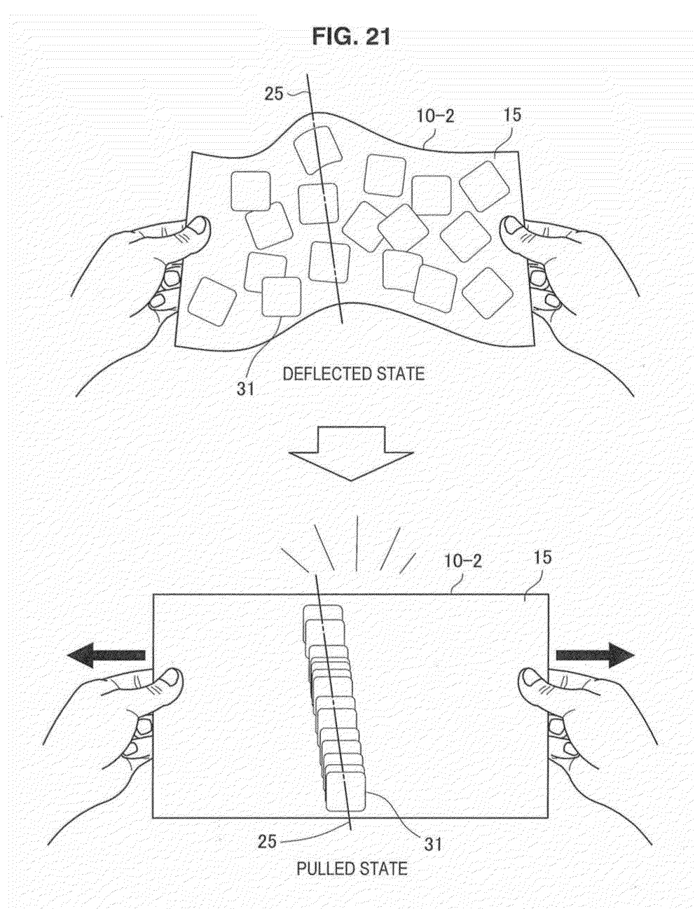

Next, Display Control Example 2 will be described in which the control unit 115 aligns icons 31 along a center line 25 of curve recognized by the recognition unit 110, in the aforementioned first embodiment, Operation Example 1 has been described with reference to FIGS. 7 and 8 in which the icons 31 are aligned when the state of the information processing device rapidly changes from the deflected state to the pulled state. In Display Control Example 2 according to the second embodiment, an input of an operation of rapidly changing the state from the deflected state to the pulled state according to the first embodiment is combined with an input of a curving operation according to this embodiment. Hereinafter, specific description will be made with reference to FIG. 21.

FIG. 21 is a diagram illustrating control of aligning icons 31 along a center line 25 of curve in Display Control Example 2 according to the second embodiment. As shown in the upper view in FIG. 21, a user first curves the information processing device 10-2 in which icons 31 are displayed irregularly from right and left sides thereof to put the information processing device 10-2 into a deflected state, and then rapidly changes the state of information processing device 10-2 into a pulled state as shown in the lower view in FIG. 21. Then, the recognition unit 110 according to this embodiment, if the speed at which the information processing device 10-2 changes state from the deflected state to the pulled state is greater than or equal to a predetermined speed, recognizes that an operation is input, and the control unit 115 outputs a corresponding process command. Specifically, as shown in the lower view in FIG. 21, the control unit 115 performs display control of aligning icons 31 along the position of the center line 25 of curve in the deflected state (see the upper view in FIG. 21) before the information processing device 10-2 changes state into the pulled state.

### Display Control Example 3

Display Control Example 1 and Display Control Example 2 above have described a case where, when the flexible display 15 is curved, a center line 25 of curve is determined and corresponding display control is performed. However, the display control according to this embodiment is not limited thereto. For example, a state in which a corner of the flexible display 15 is folded may be recognized and corresponding display control may be performed. Hereinafter, description will be made of a case where a corner is folded in Display Control Example 2 according to the second embodiment.

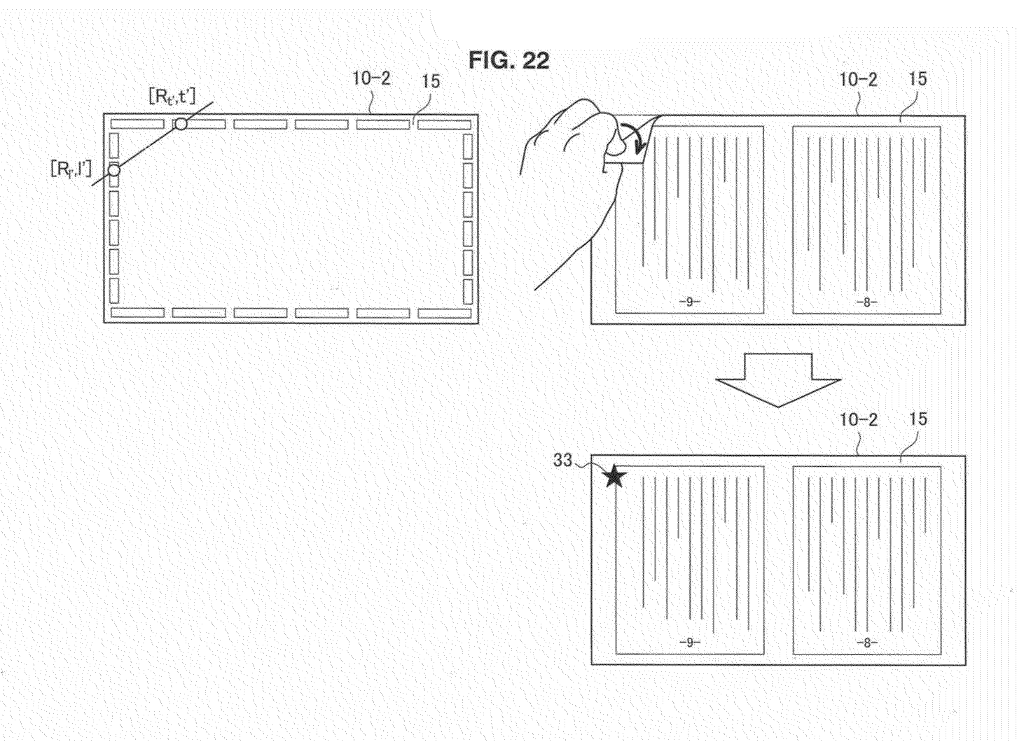

FIG. 22 is a diagram illustrating bookmark display control in Display Control Example 3 according to the second embodiment. In the example shown in FIG. 22, an electronic book is displayed on the flexible display 15. However, any information on which a bookmark function is effective, such as a WEB pager or newspaper, may be displayed.

As shown in FIG. 22, when a user folds an upper left corner of the flexible display 15, the recognition unit 110 extracts a peak position of the amount of curve on each array. For example, as shown in FIG. 22, a peak position t′ of the amount of curve on the top side is extracted, and a peak position l′ of the amount of curve on the left side is extracted. Accordingly, the recognition unit 110 can determine that the upper left corner is folded. Further, the recognition unit 110 determines if the sum of the amounts of curve at the respective peak positions is greater than or equal to a predetermined value.

Then, the recognition unit 110, when the upper left corner is folded and the sum of the amounts of curve R_{t′} and R_{l′} is greater than or equal to a predetermined IL 0 value, recognizes the folding operation of the user as an operation input, and outputs the recognition result to the control unit 115.

The control unit 115, according to the recognition result, displays a bookmark icon 33 on the upper left corner of the flexible display 15 to give visual feedback in response to the input of the folding operation by the user. In addition, the control unit 115 stores the bookmarked page into the RAM 11 or the like.

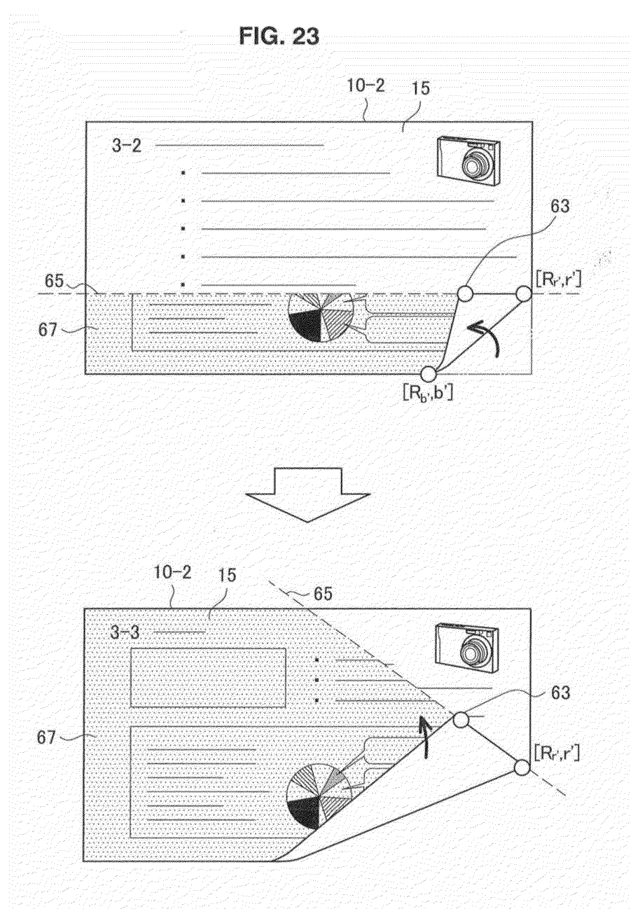

Bookmark display control has been described as an example of display control performed when a corner is folded. Note that the control unit 115 according to this embodiment may perform different control depending on which corner is folded. Hereinafter, control performed when a corner, which is different from the corner in the example shown in FIG. 22, is folded will be described with reference to FIG. 23.

FIG. 23 is a diagram illustrating page flipping display control in Display Control Example 3 according to the second embodiment. In the example shown in FIG. 23, graphic including a circle graph and texts is displayed on the flexible display 15. However, any information on which flipping of a page is effective, such as an electronic book, a Web page, or newspaper, may be displayed.

As shown in FIG. 23, when a user folds a lower right corner of the flexible display 15, the recognition unit 110 extracts a peak position r′ of the amount of curve on the right side of the flexible display 15 and extracts a peak position b′ of the amount of curve on the bottom side. Accordingly, the recognition unit 110 can determine that the lower right corner is folded. Further, the recognition unit 110 determines if the sum of the amounts of curve at the respective peak positions is greater than or equal to a predetermined value.

The recognition unit 110, if the lower right corner is folded and the sum of the amounts of curve R_{r′}, and R_{b′} is greater than or equal to a predetermined value, recognizes a folding operation of the user as an operation input, and outputs the recognition result to the control unit 115.

The control unit 115, according to the recognition result, displays displayed content of a next page in a flip region 67 of the flexible display 15 as shown in the upper view in FIG. 23.

Herein, the flip region 67 may be set according to, for example, a line segment 65 connecting the peak position r′ of the amount of curve on the right side and a folded position 63 at the lower right corner of the flexible display 15. The folded position 63 at the lower right corner can be determined by the control unit 115 using the peak position r′ of the amount of curve on the right side and the peak position b′ of the amount of curve on the bottom side.

Thus, when the lower right corner of the flexible display 15 is further folded, the position of the line segment 65 moves and the area of the flip region 67 increases as shown in the lower view in FIG. 23.

Note that setting of the flip region 67 is not limited to the aforementioned example, and the flip region 67 may be set according to a folded shape that is estimated from the peak positions r′ and b′ of the amounts of curve.

### Display Control Example 4

Display Control Examples 1-3 above have described examples in which the state of curve of the flexible display 15 when the flexible display 15 is curved from opposite sides thereof or a corner thereof is folded is recognized as an operation input and corresponding display control is performed. However, the recognition unit 110 according to this embodiment may recognize not only the aforementioned curve or fold, but also various patterns of the states of curve.

For example, the recognition unit 110 according to this embodiment may recognize a state in which a user holds one end of the flexible display 15 by hand (held state). Hereinafter, a case where a holding state of a user is recognized and corresponding display control is performed will be described as Display Control Example 4 according to the second embodiment.

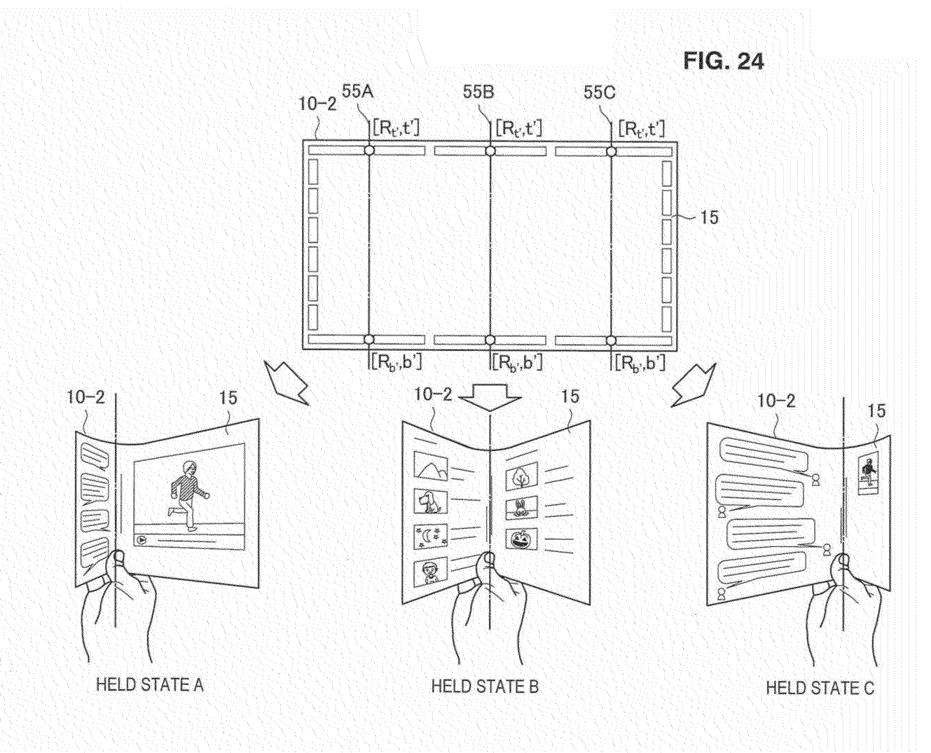

FIG. 24 is a diagram illustrating display control according to a held state in Display Control Example 4 according to the second embodiment. When a user holds one end of the flexible display 15 and the flexible display 15 is deflected, the recognition unit 110 extracts a held position on the basis of the amount of curve detected from each curvature sensor 20.

The position at which a curvature sensor 20, which has detected the largest amount of curve R (the curve amount peak position) among the curvature sensors 20 on the entire arrays, is provided may be determined to be a held position, for example. In the example shown in FIG. 24, a held position b′ on the bottom side of the flexible display 15 is extracted.

In addition, the recognition unit 110 extracts a center position t′ of curve on the top side that is opposite the bottom side including the held position and determines a held folded line segment 55 that connects the held position b′ and the center position t′ of curve.

The recognition unit 110, by determining the held position and the held folded line segment 55 according to the held position on the basis of each of the detection results (the amount of curve) obtained from the plurality of curvature sensors 20, recognizes the held state as an operation input and outputs the recognition result to the control unit 115. Note that the recognition unit 110 may add a condition that the amount of curve R′ at the curve amount peak position should be greater than or equal to a predetermined threshold to the conditions of recognizing a held state as an operation input.

Then, the control unit 115, on the basis of the recognition result, performs control according to the proportion of the display area of the flexible display 15 that is bifolded at the held folded line segment 55. For example, as shown in the held states A to B in the lower view in FIG. 24, movie playback, comment display; playlist display, and the like are performed according to the proportion of division.

More specifically, when the flexible display 15 is bifolded at a held folded line segment 55A located at a left part of the flexible display 15, the control unit 115 performs control such that a comment is displayed in the narrower display area and a movie is played back in the wider display area as indicated by the held state A in the lower view in FIG. 24.

In addition, when the flexible display 15 is bifolded at the held folded line segment 55B located at the center of the flexible display 15, the control unit 115 performs control such that a playlist of movies is displayed at each of the display areas as indicated by the held state B in the lower view in FIG. 24.

Further, when the flexible display 15 is bifolded at the held folded line segment 55C located at a right part of the flexible display 15, the control unit 115 performs control such that a movie is played back in the narrower display area and a comment is displayed in the wider display area as indicated by the held state C in the lower view in FIG. 24.

### Display Control Example 5

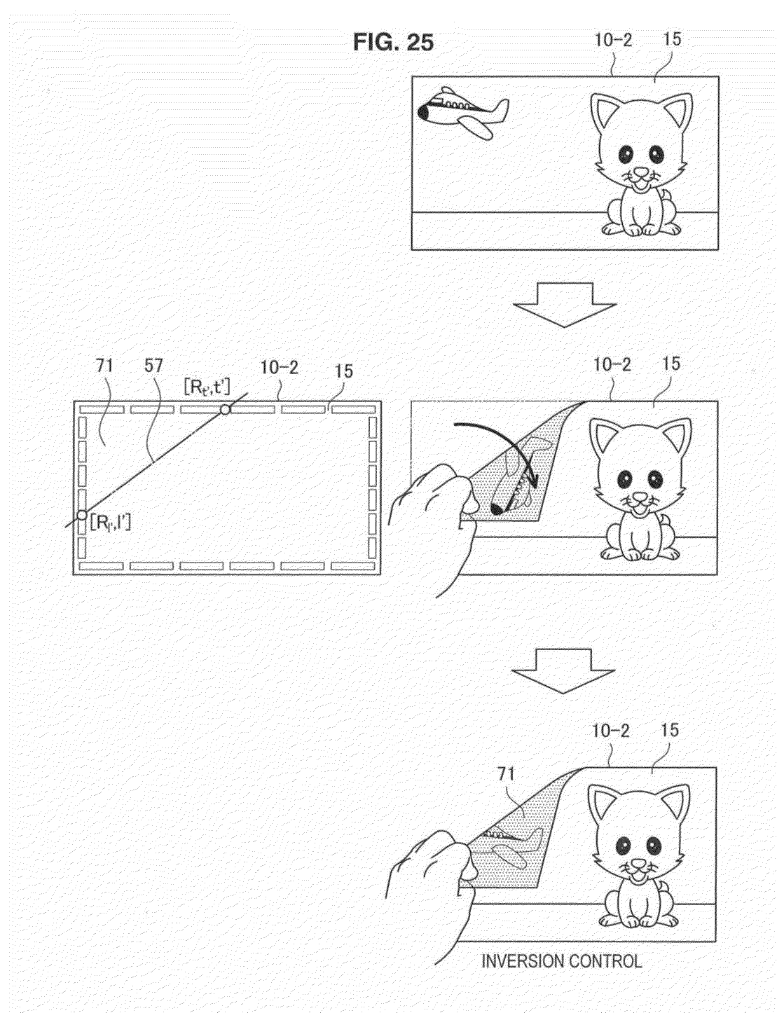

Although the light transmittance of the aforementioned information processing device 10-2 has not been particularly mentioned, when the information processing device 10-2 has light transmittance, the displayed content on the front side is seen transparently from the rear side, but the displayed content is inverted. Thus, as Display Control Example 5 according to the second embodiment, display inversion control will be described with reference to FIG. 25.

As shown in the upper view in FIG. 25, when an image is displayed on the flexible display 15 of the information processing device 10-2 having light-transmittance, if the edge of the information processing device 10-2 is folded as shown in the center right view in FIG. 25, the image on the front side is seen transparently from the rear side, but the displayed content is inverted. In this case, the recognition unit 110 determines a folded line segment 57 connecting the peak positions t′ and l′ of the amounts of curve as shown in the left view in FIG. 25, recognizes that an operation is input, and outputs the recognition result to the control unit 115. Note that the recognition unit 110 may add a condition that the sum of the amounts of curve at the respective curve amount peak positions (the sum of the amounts of curve R_{t′} and R_{l′} in the example shown in FIG. 25) should be greater than or equal to a predetermined threshold to the conditions of recognizing an operation input.

Then, the control unit 115, on the basis of the recognition result, performs control (inversion control) of matching the orientation of the displayed content in the folded area 71, which is surrounded by the folded line segment 57, the top side, and the left side, to the orientation of the displayed content on the front side. Accordingly, as shown in the lower view in FIG. 25, an image that is seen transparently in the folded area 71 of the flexible display 15 is displayed in the same orientation as the image on the front side.

Meanwhile, even when the information processing device 10-2 does not have light-transmittance and has a flexible display 15 on each side, the control unit 115 can control the orientation of the displayed content in response to an input of a folding operation. More specifically, when the information processing device 10-2 having the flexible display 15 on each side is folded as shown in FIG. 25, the display on the rear side is seen from the front side, but the displayed content is oriented in the horizontal direction. Thus, the control unit 115, in response to an input of a folding operation of a user, controls the display on the rear side and changes the orientation of the displayed content of a portion that is seen from the front side.

As described above, according to the second embodiment of the present disclosure, it is possible to, by arranging a plurality of curvature sensors 20 on each side of the information processing device 10-2, extract the amount of curve and the position of the curve, and also recognize the state of curve of the information processing device 10-2 on the basis of such information. In addition, according to the second embodiment, it is possible to recognize the thus recognized state of curve as an operation input and output a corresponding process command.

### 2-3. Third Embodiment

### Summary

Next, a third embodiment according to the present disclosure will be described. In the aforementioned second embodiment, a physically curved state of the information processing device 10 is recognized as an operation input and a corresponding process command is output. However, no mention is made of a point that a physically rolled-up state of the information processing device 10 is recognized as an operation input.

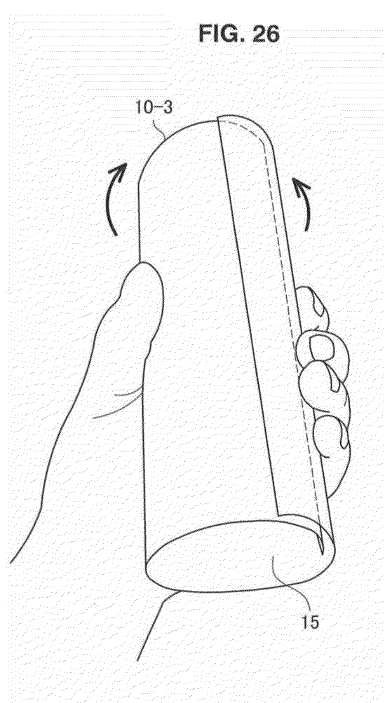

Thus, according to the third embodiment, it is possible to, on the basis of a detection result obtained by a deflection detection unit (curvature sensors), recognize a state in which the display screen (the flexible display 15) is physically rolled up as shown in FIG. 26 as an operation input and output a corresponding process command. Accordingly; in the third embodiment of the present disclosure, it is possible to realize an input of an operation effect by physically rolling up the display screen.

The hardware configuration and the functional configuration of the information processing device 10-3 that realizes an input of an operation effected by physically rolling up the display screen according to this embodiment are as described in “1-1. Hardware Configuration” and “1-2. Functional Configuration.” Next, recognition of a roiled-up state by the recognition unit 110 according to this embodiment will be described.

### Recognition of Rolled-Up State

The recognition unit 110 according to the third embodiment (see FIG. 4) determines if the information processing device 10-3 is in a rolled-up state on the basis of the amount of curve detected from curvature sensors 20 provided on each side of the information processing device 10-3 (the flexible display 15). More specifically, the recognition unit 110 can determine if the information processing device 10-3 is in a rolled-up state by comparing the detected amount of curve with a threshold indicating an amount of curve (e.g., 360°) in a closed state in which the information processing device 10-3 is rolled up one turn.

For example, when a plurality of curvature sensors 20 are provided on each array of the flexible display 15 as shown in FIG. 3 and the information processing device 10-3 is rolled up by a user, the recognition unit 110 acquires the amount of curve from each of the plurality of curvature sensors 20 on the respective arrays.

Then, the recognition unit 110 determines the sum of the amounts of curve R on each array, that is, the sum of the amounts of curve on the top side sumR(t), the sum of the amounts of curve on the bottom side sumR(b), the sum of the amounts of curve on the left side sumR(l), and the sum of the amounts of curve on the right side sumR(r).

Note that when a single curvature sensor 20 is provided on each side of the information processing device 10-3 (the flexible display 15), the amount of curve detected from each curvature sensor 20 may be defined as sumR.

Then, the recognition unit 10 determines the state of the information processing device 10-3 by comparing each of the two largest sumR among the thus determined sumR with a threshold (hereinafter, a threshold v) indicating the sum of the amounts of curve on one side (e.g., 360°).

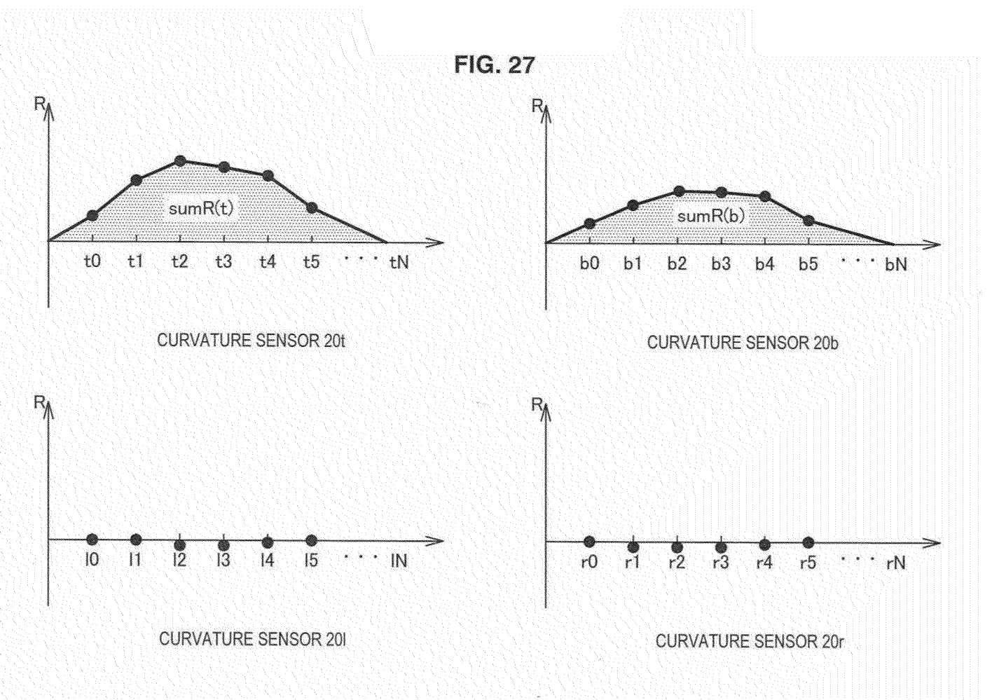

For example, in the example shown in FIG. 27, sumR(t) and sumR(b) are the two largest sums of the amounts of curve. Thus, when sumR(t) and sumR(b) satisfy the aforementioned threshold v, the recognition unit 110 determines that the information processing device 10-3 is in a rolled-up state and thus recognizes that an operation is input. Thus, the recognition unit 110 outputs the recognition result to the control unit 115, and outputs a corresponding process command on the basis of the recognition result.

Although the description has been made of a case where it is recognized that a roll-up operation is input when the threshold v is satisfied, this embodiment is not limited thereto. For example, a threshold indicating a sum of the amounts of curve such as 720° that is presumed when the information processing device 10-3 is rolled-up two turns (hereinafter, a threshold w) may be used. The recognition unit 110 recognizes that a double-roll-up operation is input when each of the highest sumR satisfies the threshold w. Accordingly, it is possible to increase the recognition accuracy for the rolled-up state of the information processing device 10-3 and increase the variation of the corresponding process command.

In addition, although the example described above with reference to FIG. 27 determines a rolled-up state of the information processing device 10-3 by comparing each of the two highest sumR with the threshold v, this embodiment is not limited thereto. For example, the recognition unit 110 may determine the rolled-up state by comparing the amount of curve of each of the curvature sensors 20 arranged on each array with a threshold o. The threshold o is a threshold indicating the amount of curve of each curvature sensor on the rolled-up side that is presumed when the information processing device 10-3 is rolled up one turn.

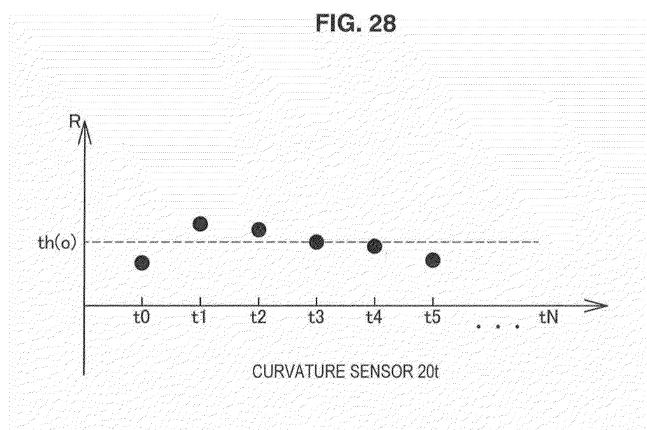

For example, in the example shown in FIG. 28, as the amount of curve of each of the curvature sensors 20t-t0 to 20t-tN arranged on the top side are dispersed with respect to the threshold o, the recognition unit 110 can recognize that the top side is rolled up. As described above, when the amount of curve of each individual curvature sensor is compared with the threshold o, it becomes possible to avoid a circumstance that the information processing device 10-3 is erroneously determined to be rolled up even when only one part has a large amount of curve among the sum of the amounts of curve sumR. Thus, recognition accuracy for the rolled-up state can be further improved.

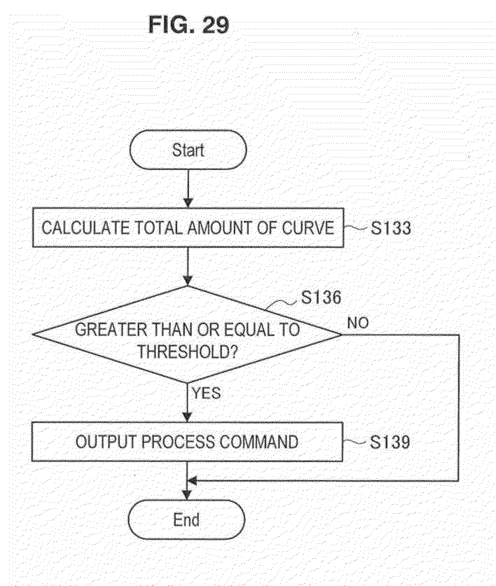

Recognition of the roiled-up state according to the third embodiment has been described in detail above. Next, an example of an operation process according to this embodiment will be described with reference to FIG. 29.

### Operation Process

FIG. 29 is a flowchart illustrating an example of an operation process according to the third embodiment. Note that in the example shown in FIG. 29, a rolled-up state is recognized using the sum of the amounts of curve sumR described above with reference to FIG. 27.

As shown in FIG. 29, in step S133, the recognition unit 110 first calculates the total amount of curve (the sum of the amounts of curve sumR) on each array. Next, in step S136, the recognition unit 110 determines if the two largest total amounts of curve sumR are greater than or equal to the threshold v.

In step S136, if each of the total amounts of curve sumR is greater than or equal to the threshold v, the recognition unit 110 determines that the information processing device 10-3 is in a rolled-up state, and outputs information to the effect that an input of a roll-up operation is recognized to the recognition unit 110 as a recognition result.

Next, in step S139, the control unit 115 outputs a corresponding process command on the basis of the recognition result output from the recognition unit 110.

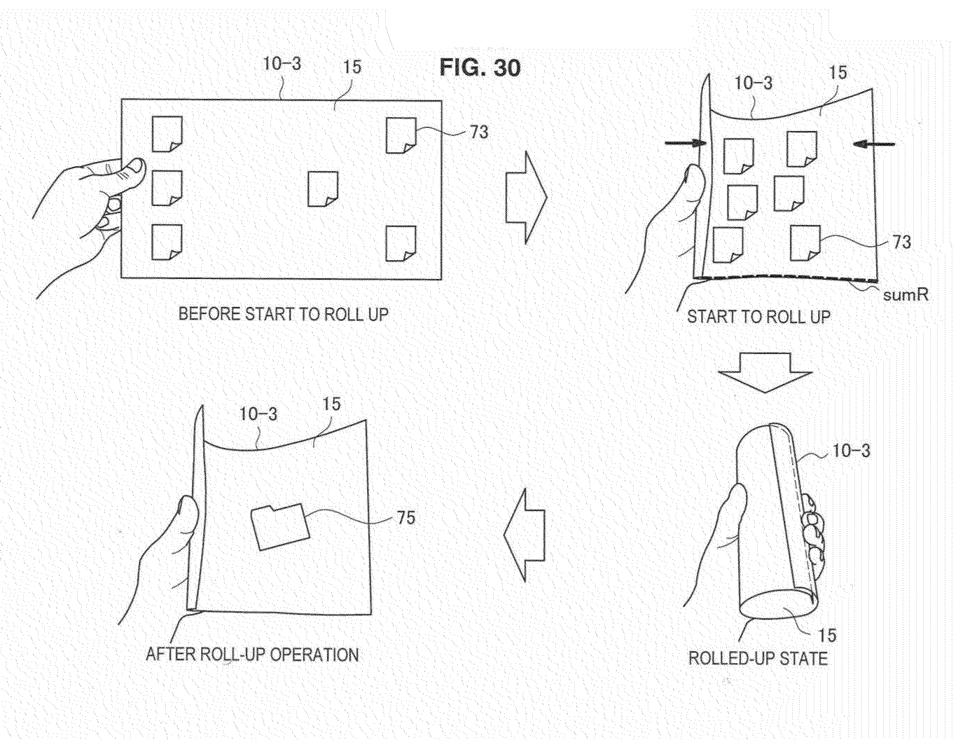

Hereinabove, an operation process according to the third embodiment has been described. Although a process command output from the control unit 115 in step S139 is not particularly limited, the process command may be the one that makes a user feel intuitively that the command is related to a roll-up operation, for example. The roll-up operation is similar to a sense of operation of “collecting” for the user. Herein, by executing a process command (function) of collecting a plurality of files on the basis of such sense of operation, it becomes possible to realize an intuitive operation input. Hereinafter, an example of function to be executed will be described with reference to FIG. 30.

### Execution of Function

FIG. 30 is a diagram illustrating a function executed by the control unit 115 according to the third embodiment in response to an input of a roll-up operation. As indicated by “before start to roll up” in FIG. 30, in a state in which a plurality of file icons 73 are displayed on the flexible display 15, a user rolls up the information processing device 10-3.

The control unit 115, as indicted by “start, to roll up” in FIG. 30, causes the display positions of the plurality of files 73 to move close to each other according to the sum of the amounts of curve sumR on each side that gradually changes, thereby expressing the degree of collection of the plurality of files 73.

Further, the user rolls up the information processing device 10-3 to cause the information processing device 10-3 to be in a state of being rolled up one turn or more as indicated by the “rolled-up state” in FIG. 30. The recognition unit 110 calculates the sum of the amounts of curve on each array of the flexible display 15 and, if each of the two largest sumR among the calculated sumR is greater than or equal to the threshold v, determines that the information processing device 10-3 is in a rolled-up state, and thus recognizes that a roll-up operation is input.

Next, the control unit 115 executes a function (conversion function) of colleting the plurality of file icons 73 into a single folder according to the recognition of the input of the roll-up operation by the recognition unit 110.

In addition, the control unit 115 displays a folder icon 75 indicating a collection of a plurality of files on the flexible display 15 as indicated by “after roll-up operation” in FIG. 30.

Hereinabove, a specific function executed in response to an input of a roll-up operation has been described. Note that when the information processing device 10-3 is rolled up one turn or more, parts of the information processing device 10-3 overlap one another, and the overlapping portion is pressed with a finger as indicated by “rolled-up state” in FIG. 30. Thus, when the information processing device 10-3 has a structure with a touch panel, if the information processing device 10-3 is rolled up and a partially overlapping portion is pressed with a finger, it is concerned that a touch operation may unintentionally be detected.

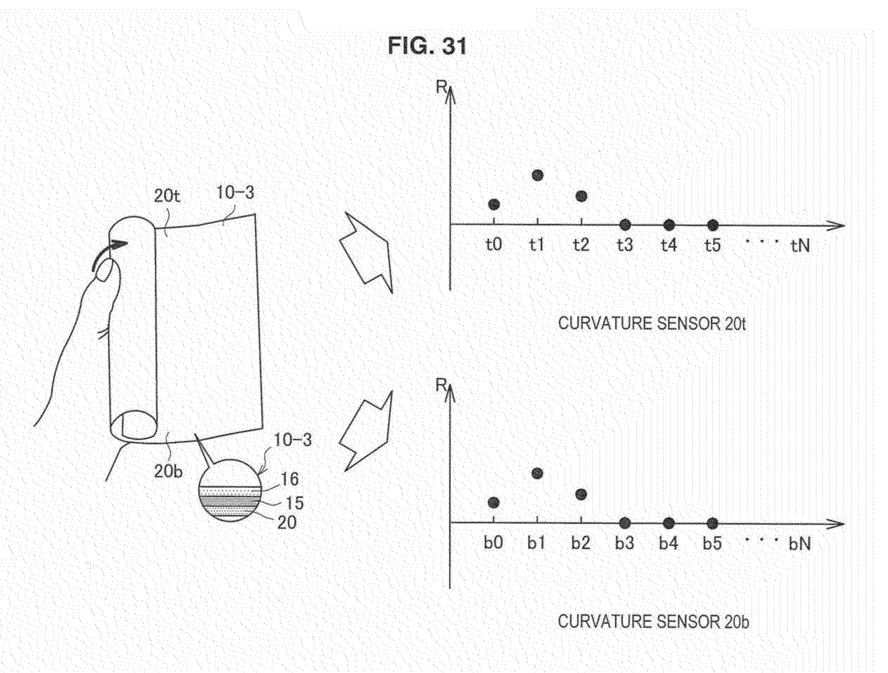

Accordingly, when it is recognized that the information processing device 10-3 is rolled up one turn or more, for example, the control unit 115 may temporarily turn off the touch panel function (touch operation detection function). Alternatively, the control unit 115 may turn off the touch operation detection function for only a part of the areas of the touch panel. A case where the function of only a part of the areas of the touch panel is turned off will be hereinafter described with reference to FIG. 31.

FIG. 31 is a diagram illustrating that the control unit 115 according to the third embodiment turns off the touch operation detection function according to the rolled-up state. As shown in FIG. 31, the information processing device 10-3 has a structure in which the flexible touch panel 16, the flexible display 15, and the curvature sensor 20 are stacked. As shown to the left of FIG. 31, when a part of the information processing device 10-3 is rolled up, the curvature sensor 20t arranged on the top side of the information processing device 10-3 and the curvature sensor 20h arranged on the bottom side thereof detect a signal sequence of the amount of curve R as shown to the right of FIG. 31.

The recognition unit 110 recognizes, on the basis of the amount of curve R acquired from each curvature sensor 20, recognizes which area of the information processing device 10-3 is rolled up one turn or more. For example, the recognition unit 110 may, on the basis of each of the amounts of curve detected from the curvature sensors 20, estimate the stereoscopic shape of the information processing device 10-3 and recognize an area that is rolled up one turn or more. Then, the control unit 115 may turn off the touch operation detection function of the area. Specifically, for example, the control unit 115 may discard the touch operation detected from the area of the flexible touch panel 16.

As described above, according to the third embodiment of the present disclosure, it is possible to, on the basis of the amount of curve detected from the curvature sensor 20, recognize a state in which the display screen is physically rolled up as an operation input and output a corresponding process command.

### 3. Conclusion

As described above, according to the first embodiment of the present disclosure, it is possible to, by recognizing a change in physical deflection of the information processing device 10-1 and outputting a corresponding process command, improve the convenience of inputting a curving operation. In addition, it is also possible to realize an intuitive operation input by outputting a process command associated with a sense of a deflection operation.

In addition, according to the second embodiment of the present disclosure, it is possible to, by arranging a plurality of curvature sensors on each side of the information processing device 10-2, extract the amount of curve and the position of the curve, and further recognize the state of curve of the information processing device 10-2 on the basis of such information. Further, according to the second embodiment, it is possible to recognize the thus recognized state of curve as an operation input and output a corresponding process command.

Furthermore, according to the third embodiment of the present disclosure, it is possible to, on the basis of the amount of curve detected from the curvature sensor 20, recognize a state in which the display screen is physically rolled up as an operation input and output a corresponding process command.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

It should be understood by those skilled in the art that various modifications, combinations, sub-combinations and alterations may occur depending on design requirements and other factors insofar as they are within the scope of the appended claims or the equivalents thereof.

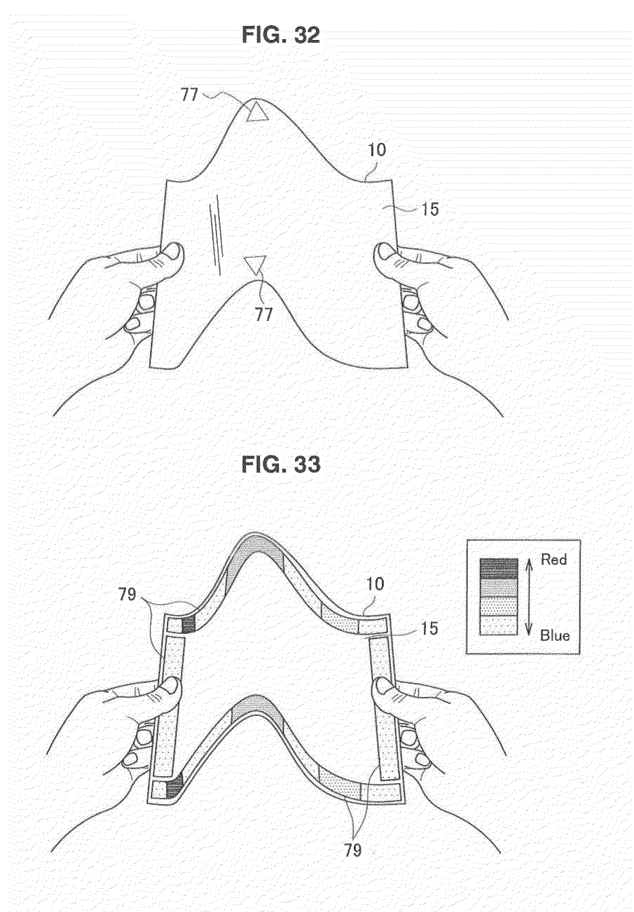

For example, in each of the aforementioned embodiments, it is also possible to perform display control of indicating a center line of curve of the flexible display 15 to give visual feedback in response to a curving operation. Specifically, in the structure in which the flexible display 15 is stacked on the curvature sensor 20, it is also possible to indicate portions where a center line of curve is recognized to be located by icons 77 such as arrows or triangles as show in FIG. 32, for example.

In addition, as shown in FIG. 33, it is also possible to display a color display 79, which is selectively colored according to the magnitude of the amount of curve, on each side by for example, displaying a portion where the detected amount of curve is larger in color that is close to red and displaying a portion where the detected amount of curve is smaller in color that is close to blue.

Additionally, the present technology may also be configured as below.

(1) An information processing device including:

a display screen having flexibility;

a deflection detection unit configured to detect deflection of the display screen; and

a control unit configured to recognize a change in the deflection detected by the deflection detection unit as an on operation input and output a correspond process command.

(2) The information processing device according to (1), wherein the control unit outputs a process command according to a periodic change in an amount of the deflection detected by the deflection detection unit.
(3) The information processing device according to (4 wherein the control determines the corresponding process command by comparing a prestored pattern with the periodic change in the amount of the deflection.
(4) The information processing device according to (1), wherein the control unit outputs the process command according to a change in state between a pulled state and a deflected state of the display screen on the basis of a detection result obtained by the deflection detection unit.
(5) The information processing device according to any one of (1) to (4), wherein the control unit outputs a process command for switching displayed content according to the change in the deflection.
(6) The information processing device according to any one of (1) to (4), wherein the control unit outputs a process command for transmitting data on an object displayed on the display screen to a nearby communication terminal according to the change in the deflection.
(7) A control method including:

detecting deflection of a display screen having flexibility; and

recognizing a change in the deflection detected in the deflection detection step as an on operation input and outputting a corresponding process command.

(8) A program for causing a computer to execute the processes of:

detecting deflection of a display screen having flexibility; and

performing control of recognizing a change in the deflection detected in the deflection detection process as an on operation input and outputting a corresponding process command.

(9) The program according to (8), wherein the controlling process includes outputting a process command according to a periodic change in an amount of the deflection detected in the deflection detection process.
(10) The program according to (9), wherein the control process includes determining the corresponding process command by comparing a prestored pattern with the periodic change in the amount of the deflection.
(11) The program according to (8), wherein the controlling process includes outputting the process command according to a change in state between a pulled state and a deflected state of the display screen on the basis of a detection result obtained by the deflection detection unit.
(12) The program according to any one of (8) to (11), wherein the controlling process includes outputting a process command for switching displayed content.
(13) The program according to any one of (8) to (12), wherein the controlling process includes outputting a process command for transmitting data on an object displayed on the display screen to a nearby communication terminal according to the change in the deflection.

The present disclosure contains subject matter related to that disclosed in Japanese Priority Patent Application JP 2011-248605 filed in the Japan Patent Office on Nov. 14, 2011, the entire content of which is hereby incorporated by reference.

What is claimed is:

1. An information processing device comprising:
a display screen haying flexibility;
a deflection detection unit configured to detect deflection of the display screen; and
a control unit configured to recognize a change in the deflection detected by the deflection detection unit as an on operation input and output a corresponding process command.

2. The information processing device according to claim 1, wherein the control unit outputs a process command according to a periodic change in an amount of the deflection detected by the deflection detection unit.

3. The information processing device according to claim 2, wherein the control unit determines the corresponding process command by comparing a prestored pattern with the periodic change in the amount of the deflection.

4. The information processing device according to claim 1, wherein the control unit outputs the process command according to a change in state between a pulled state and a deflected state of the display screen on the basis of a detection result obtained by the deflection detection unit.

5. The information processing device according to claim 1, wherein the control unit outputs a process command for switching displayed content according to the change in the deflection.

6. The information processing device according to claim 1, wherein the control unit outputs a process command for transmitting data on an object displayed on the display screen to a nearby communication terminal according to the change in the deflection.

7. A control method comprising:
detecting deflection of a display screen having flexibility; and
recognizing a change in the deflection detected in the deflection detection step as an on operation input and outputting a corresponding process command.

8. A program for causing a computer to execute the processes of
detecting deflection of a display screen having flexibility; and
performing control of recognizing a change in the deflection detected in the deflection detection process as an on operation input and outputting a corresponding process command.

9. The program according to claim 8, wherein the controlling process includes outputting a process command according to a periodic change in an amount of the deflection detected in the deflection detection process.

10. The program according to claim 9, wherein the control process includes determining the corresponding process command by comparing a prestored pattern with the periodic change in the amount of the deflection.

11. The program according to claim 8, wherein the controlling process includes outputting the process command according to a change in state between a pulled state and a deflected state of the display screen on the basis of a detection result obtained by the deflection detection unit.

12. The program according to claim 8, wherein the controlling process includes outputting a process command for switching displayed content.

13. The program according to claim 8, wherein the controlling process includes outputting a process command for transmitting data on an object displayed on the display screen to a nearby communication terminal according to the change in the deflection.
